(19) United States
(12) Patent Application Publication
(10) Pub. No.: US 2026/0237144 A1
(43) Pub. Date: Aug. 13, 2026

(54) INFORMATION PROCESSING APPARATUS, INFORMATION PROCESSING METHOD, INFORMATION PROCESSING SYSTEM, AND STORAGE MEDIUM

(71) Applicant: CANON KABUSHIKI KAISHA, Tokyo (JP)

(72) Inventor: Taku OGASAWARA, Tokyo (JP)

(21) Appl. No.: 19/443,173

(22) Filed: Jan. 8, 2026

(30) Foreign Application Priority Data
Feb. 7, 2025 (JP) 2025-019135

(51) Int. Cl. G06T 15/10

(52) U.S. Cl. CPC G06T 15/10

(57) ABSTRACT

Provided is an information processing apparatus configured to set a configuration of an information processing system including an image generation server configured to generate a virtual viewpoint image corresponding to a viewpoint based on inputted data, which is information related to the viewpoint and material data, and a transmission server configured to transmit the inputted material data, the information processing apparatus including: an obtainment unit configured to obtain first information indicating a transmittable data amount per unit time in the transmission server, second information indicating a data amount of the material data inputted to the information processing system, and third information indicating the number of the image generation server; and a determination unit configured to determine the number of the transmission server based on the first information, the second information, and the third information.

### BACKGROUND

### Field of the Technology

The present disclosure relates to a distribution processing technique of a virtual viewpoint image.

### Description of the Related Art

There has been a technique of generating an image corresponding to a view from an arbitrary viewpoint (hereinafter, referred to as a "virtual viewpoint image") by generating three-dimensional shape data representing a three-dimensional shape of an object by using multiple images obtained by image capturing with multiple cameras and rendering the generated three-dimensional shape. Japanese Patent Laid-Open No. 2019-145017 discloses a technique of generating and reproducing a virtual viewpoint image by saving information to generate the virtual viewpoint image in a case of generating the virtual viewpoint image and obtaining and rendering the saved information by multiple user terminals.

### SUMMARY

An information processing apparatus according to an aspect of the present disclosure is an information processing apparatus configured to set a configuration of an information processing system including an image generation server configured to generate a virtual viewpoint image corresponding to a viewpoint based on inputted data, which is information related to the viewpoint and material data, and a transmission server configured to transmit the inputted material data, the information processing apparatus including: at least one memory that stores instructions; and at least one processor that executes the instructions to: obtain first information indicating a transmittable data amount per unit time in the transmission server, second information indicating a data amount of the material data inputted to the information processing system, and third information indicating the number of the image generation server; and determine the number of the transmission server based on the first information, the second information, and the third information.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams illustrating an example of an overall system configuration;

FIGS. 2A to 2E are diagrams illustrating a database configuration example of volumetric data;

FIGS. 3A to 3D are diagrams illustrating a virtual camera example;

FIG. 4 is a diagram illustrating a configuration example of a distribution system;

FIG. 5 is a flowchart illustrating a flow of structuring processing of a distribution connection configuration;

FIGS. 6A to 6C are diagrams illustrating a distribution connection configuration database example;

FIGS. 7A to 7C are diagrams illustrating a configuration example of a server device;

FIGS. 8A to 8C are flowcharts illustrating a flow of processing executed by the server device;

FIGS. 9A and 9B are diagrams illustrating a configuration example of a user terminal;

FIG. 10 is a flowchart illustrating a flow of processing executed by the user terminal; and

FIGS. 11A to 11F are diagrams illustrating a display example of the user terminal.

### DESCRIPTION OF THE EMBODIMENTS

An embodiment of a technique of the present disclosure is described below in detail with reference to the drawings. Note that, the following embodiment is not intended to limit the technique of the present disclosure according to the scope of claims. Not all the combinations of the characteristics described in the embodiment are necessarily required for the means for solving the problems of the present disclosure, and the multiple characteristics may be combined with each other as needed. The same configurations are described with the same reference numerals. Additionally, each step in a flowchart is denoted with "S" provided at the beginning.

### FIRST EMBODIMENT

In the present embodiment, a distribution system of a virtual viewpoint image (hereinafter, referred to as a "distribution system") that is an information processing system configured to provide volumetric data generated by a volumetric capture system and the like to each user terminal is described.

In multiple user terminals connected with the distribution system, it is possible to manipulate a virtual viewpoint that is a corresponding arbitrary viewpoint and to view the virtual viewpoint image from the viewpoint.

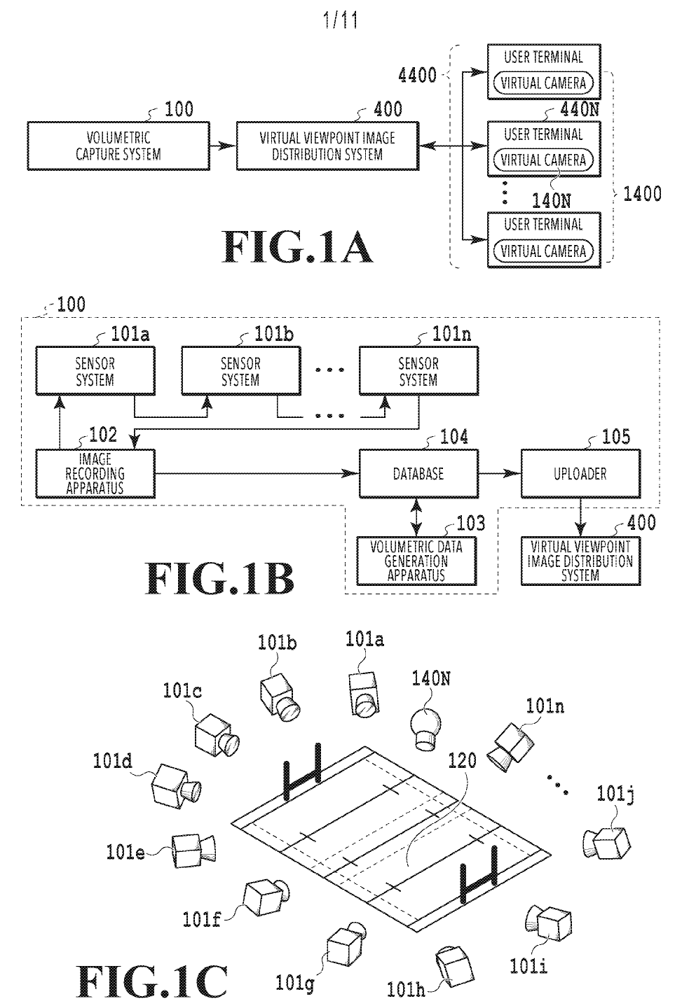

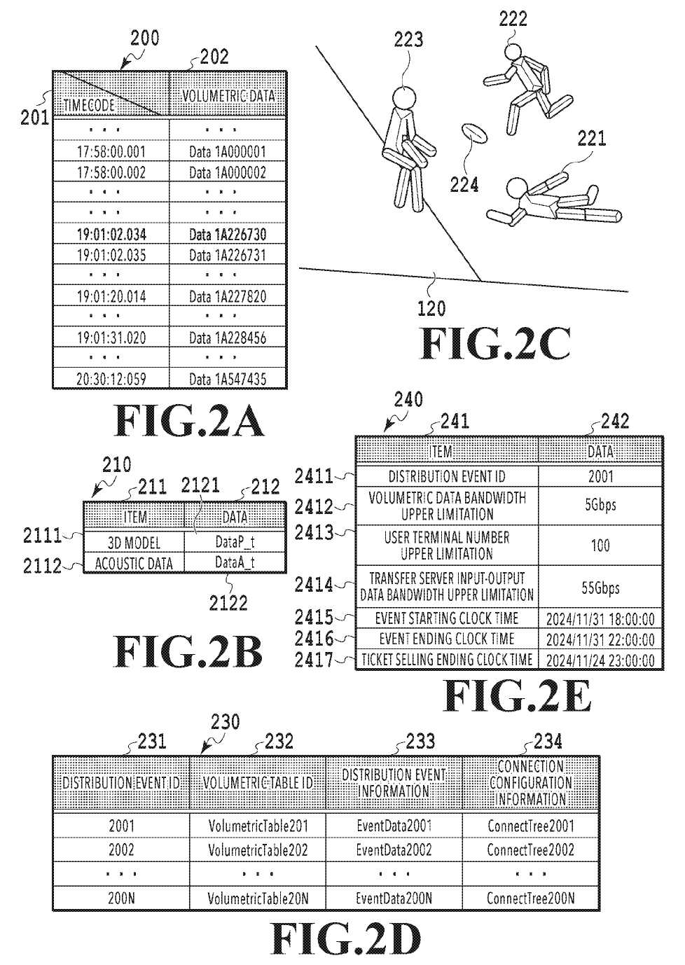

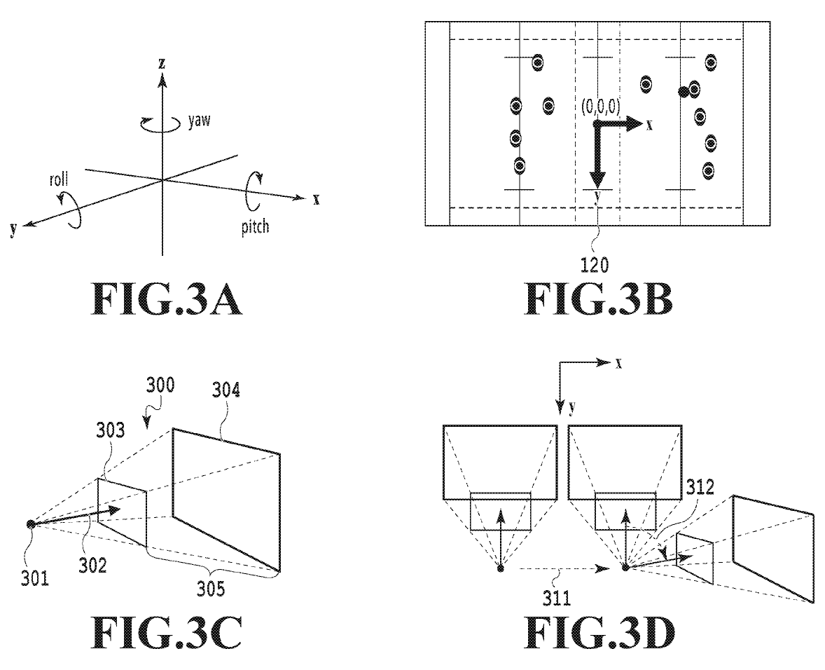

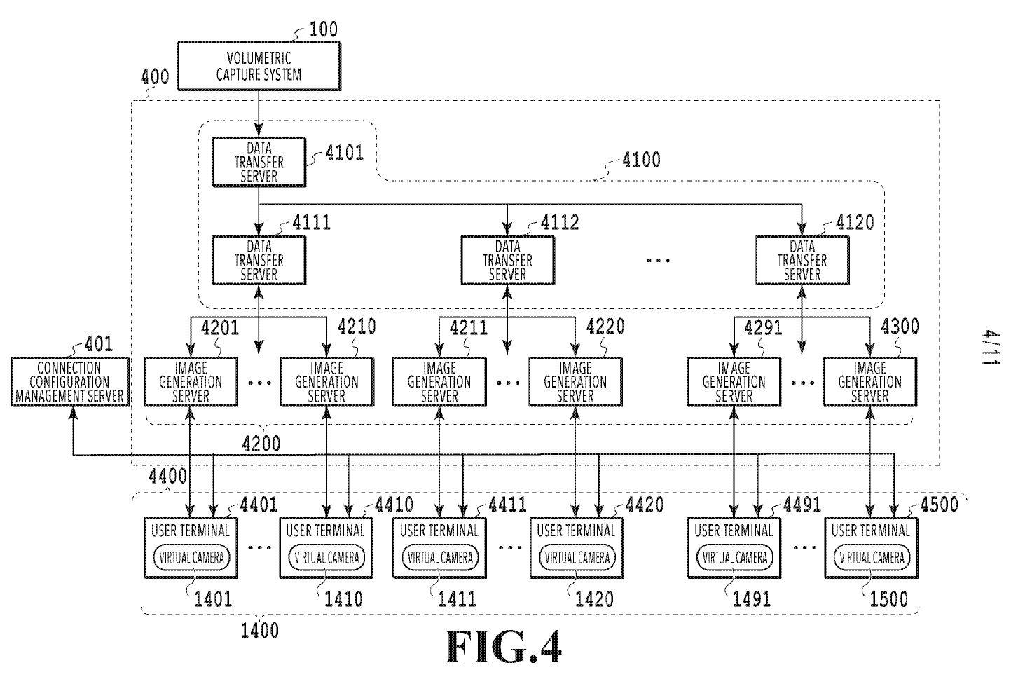

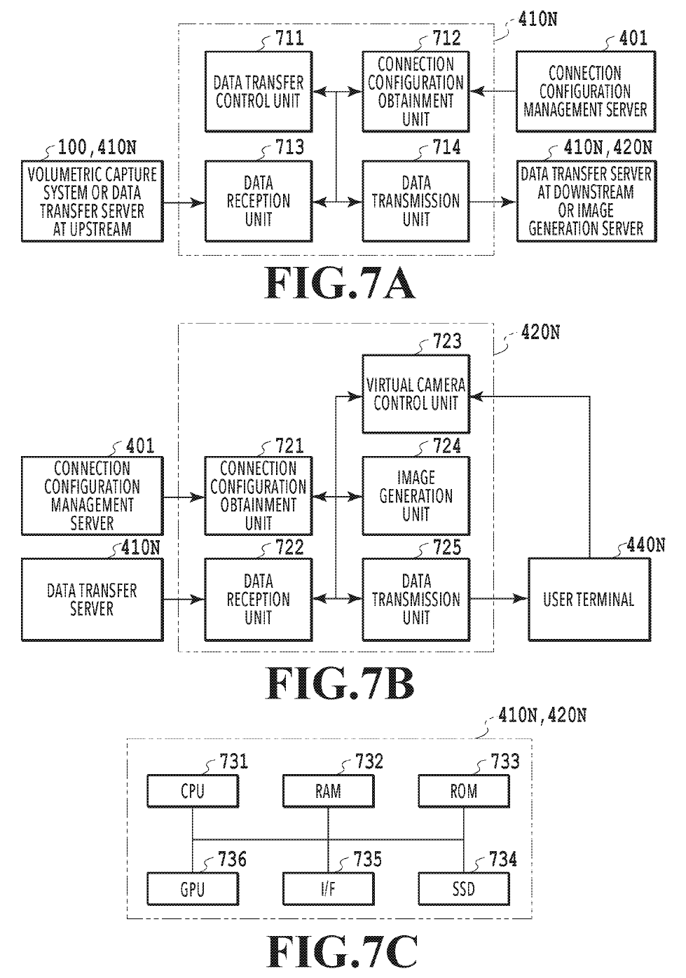

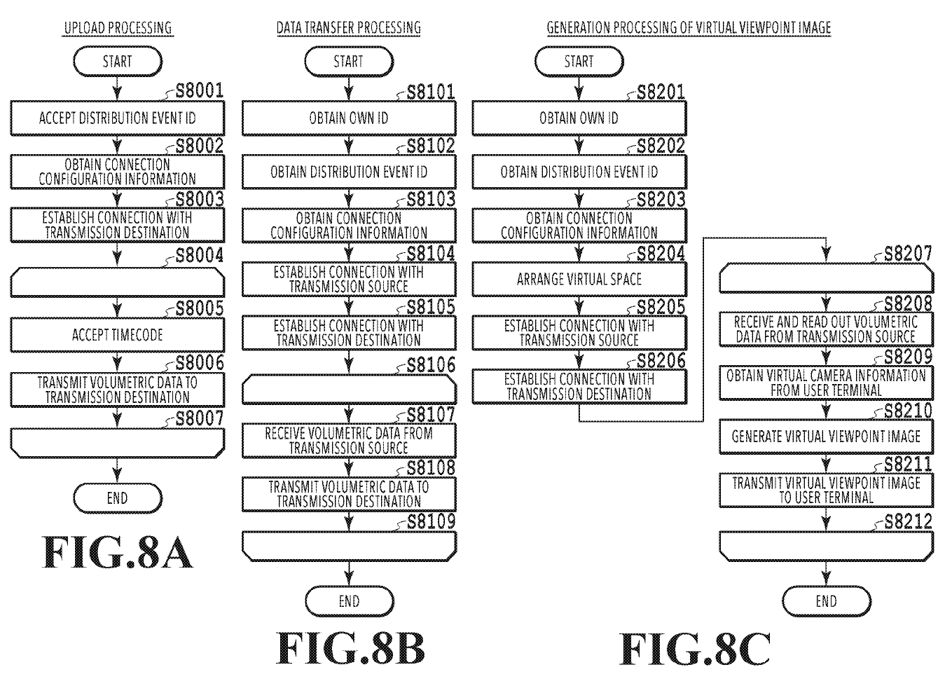

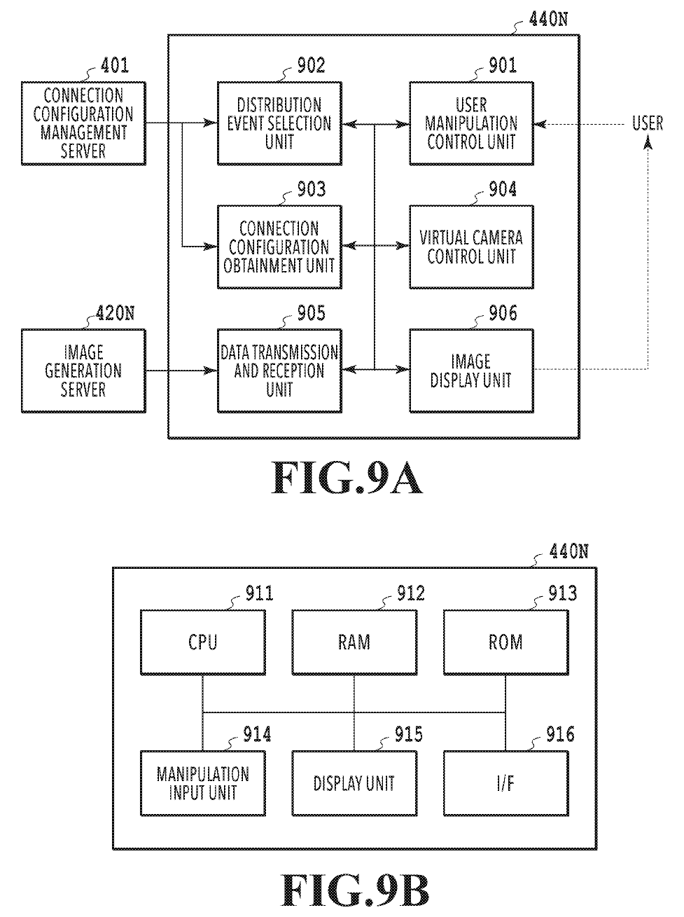

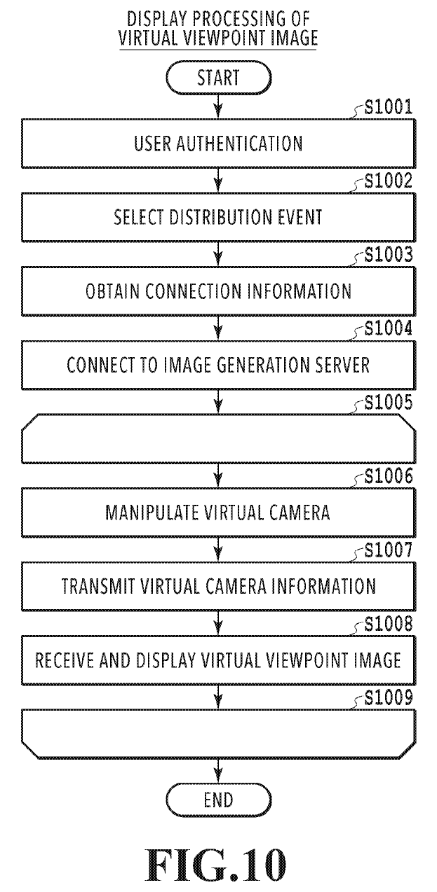

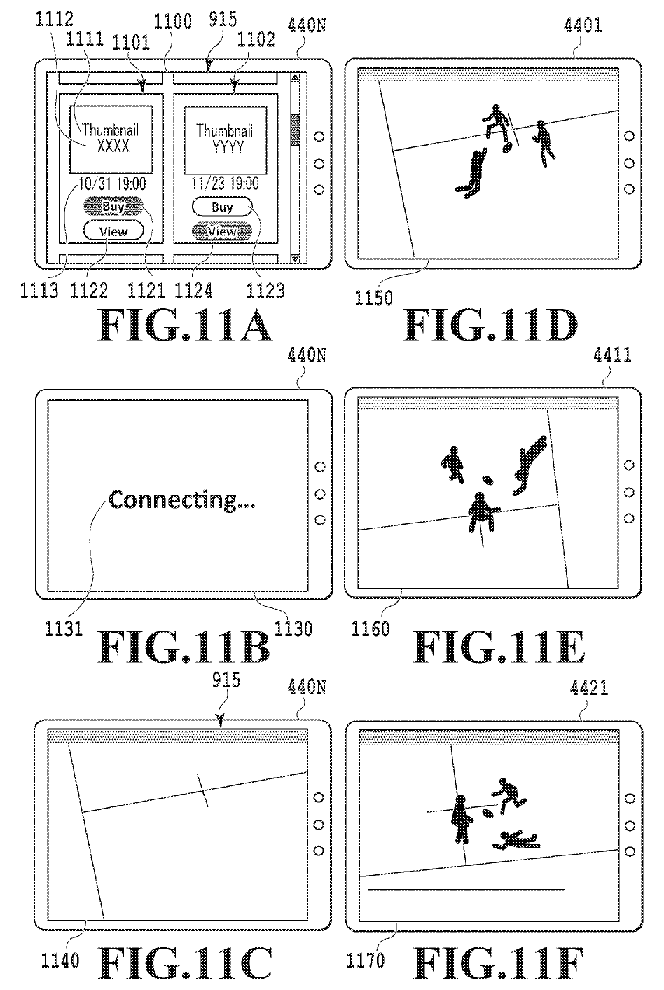

In the present embodiment, an overall system configuration and a volumetric capture system 100 and an image capturing region 120 are described with reference to FIGS. 1A to 1C. Additionally, a database configuration to manage the volumetric data is described with reference to FIGS. 2A to 2E, and a virtual camera is described with reference to FIGS. 3A to 3D. In addition, a distribution system 400 and structuring processing of a distribution connection configuration according to the present embodiment are described with reference to FIG. 4 to FIG. 6C, and a configuration and each processing of a virtual server included in the distribution system are described with reference to FIGS. 7A to 7C and FIGS. 8A to 8C. Note that, the virtual server includes a data transfer server, an image generation server, and the like. Moreover, a configuration and processing of the user terminal are described with reference to FIGS. 9A and 9B and FIG. 10, and a display example of the virtual viewpoint image on the user terminal is described with reference to FIGS. 11A to 11F.

### Overall System Configuration

FIG. 1A is a diagram illustrating a configuration example of the overall system according to the present embodiment. As illustrated in FIG. 1A, the system of the present embodiment is roughly divided into three constituents: the volumetric capture system 100; the distribution system 400; and a user terminal group 4400.

First, a functional overview of the volumetric capture system 100 is described. The volumetric capture system 100 captures an image and collects the sound of an object to generate volumetric data including a 3D model of the object, which is three-dimensional shape data of the object, and acoustic data. The volumetric capture system 100 uploads the generated volumetric data to the distribution system 400.

The distribution system 400 generates volumetric data for each user terminal 4400 from the uploaded volumetric data. Then, the distribution system 400 generates the virtual viewpoint image corresponding to a view from each viewpoint by using virtual camera information indicating position and orientation of each virtual camera 1400 inputted from each user terminal 4400 and the volumetric data for each user terminal 4400. The distribution system 400 transmits the generated virtual viewpoint image to each user terminal 4400.

The user terminal group 4400 transmits the virtual camera information to the distribution system 400, which is the virtual viewpoint information that is generated by accepting an input with a user manipulating each virtual camera 1400 independently for each user terminal and that indicates the position and orientation of each virtual camera 1400. The distribution system 400 generates each virtual viewpoint image by using the received corresponding virtual camera information.

The user terminal group 4400 is a term indicating the multiple user terminals as illustrated in FIG. 1A. A virtual camera group 1400 can be manipulated to have different arbitrary viewpoints for each user terminal independently and respectively.

The distribution system 400 transmits the generated virtual viewpoint image to each user terminal 4400 corresponding to the manipulation. Details of a display example of the virtual viewpoint image in this process are described with reference to FIGS. 11A to 11F.

Note that, in a case of collectively expressing each user terminal, it is written as the user terminal group 4400 or each user terminal 4400, and in a case of indicating one of arbitrary user terminals included in the user terminal group 4400, it is written as a user terminal 440N. In a case of collectively expressing each virtual camera manipulated by the corresponding user terminal 4400, it is written as the virtual camera group 1400 or each virtual camera 1400, and in a case of indicating one of arbitrary virtual cameras included in the virtual camera group 1400, it is written as a virtual camera 140N.

Additionally, an event in which the volumetric capture system 100 performs image capturing, and the distribution system 400 performs distribution is hereinafter referred to as a distribution event.

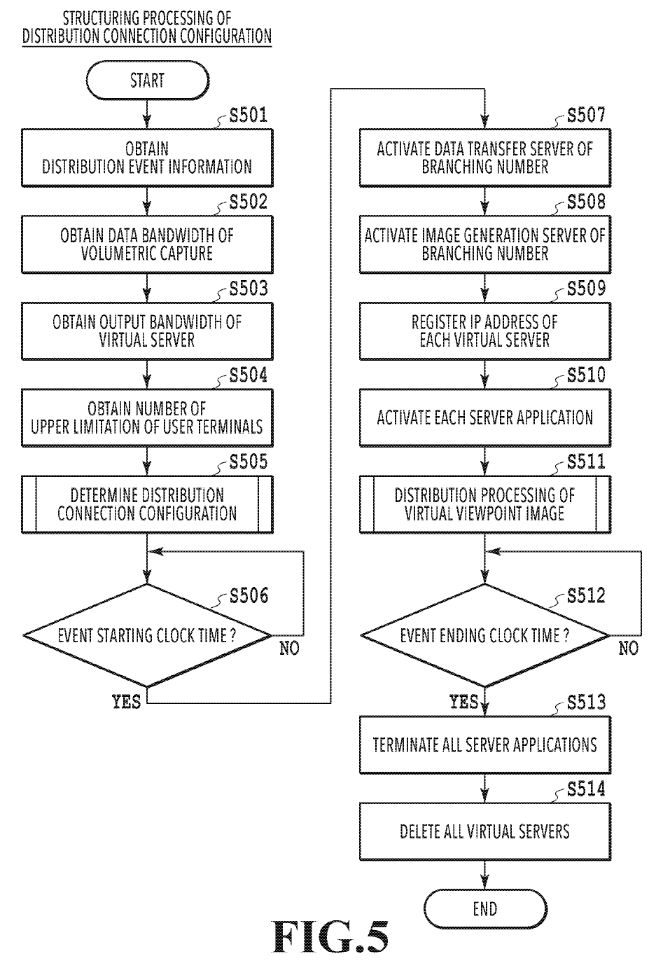

The distribution event includes a game of professional sports, a live event of an artist, and so on. The distribution event is conducted as a different event for each game or each live. The distribution system 400 is structured for each distribution event. Details of the structuring processing of the distribution system are described with reference to FIG. 5. The above is an overview of the overall system. Subsequently, details of each system are described sequentially.

### Volumetric Capture System

FIG. 1B is a diagram illustrating an overview of the volumetric capture system. As illustrated in FIG. 1B, the volumetric capture system 100 includes N sensor systems 101a to 101n, an image recording apparatus 102, a volumetric data generation apparatus 103, a database 104, and an uploader 105. Each of the sensor systems 101a to 101n includes a visible light camera (an RGB camera, which is hereinafter referred to as simply a camera) as at least one image capturing apparatus. Hereinafter, unless otherwise stated, the n sensor systems are not distinguished and are written as multiple sensor systems 101. The volumetric data generation apparatus 103 is written as a generation apparatus 103.

### Installation of Multiple Sensor Systems

FIG. 1C is a diagram illustrating an installation example of the multiple sensor systems 101. The multiple sensor systems 101 are installed to surround the image capturing region 120 as a target region of the image capturing and capture images of the image capturing region 120 from different directions, respectively.

The image capturing region 120 is, for example, a ground or the like of a stadium where a sports game is held, and the n (for example, 100) sensor systems 101 are installed to surround the ground. Note that, the number of the installed multiple sensor systems 101 is not limited to 100 and may be less than or more than 100. Note that, the image capturing region 120 is not limited to the ground of the stadium. The image capturing region 120 may be, for example, a region including the ground of the stadium and stands and the like of the stadium. Additionally, the image capturing region 120 is not limited to the stadium and may be a stage of an arena or may include a set on the stage.

The object image-captured by the volumetric capture system 100 is a body and a person existing on the image capturing region 120 as illustrated in FIG. 1C. Note that, the number of the body and the person as an image capturing target is not limited to that illustrated in FIG. 1C, and all the bodies and persons included in the image capturing region 120 are the target.

Note that, the virtual camera 140N is arranged in a virtual space associated with the image capturing region 120. The virtual camera 140N is a camera that is manipulated in the same virtual space and that is capable of viewing the image capturing region 120 from a viewpoint different from any of the cameras of the multiple sensor systems 101 with no physical restrictions. Details of the virtual camera are described with reference to FIGS. 3A to 3D.

Additionally, the multiple sensor systems 101 may not be installed at the entire periphery of the image capturing region 120 and may be installed at only a part of the periphery of the image capturing region 120 due to restrictions in the installation place and the like. Moreover, the multiple cameras (image capturing apparatuses) included in the multiple sensor systems 101 may include an image capturing apparatus of a different function such as a telephoto camera and a wide angle camera.

Each camera included in the multiple sensor systems 101 captures an image of the same object in synchronization with each other. A collectivity of multiple images from different viewpoints obtained by the image capturing by each camera is a multiple-viewpoint image. Since each camera performs the synchronized image capturing, a timecode is used by each camera as an image capturing clock time.

The timecode is information to uniquely identify the image capturing clock time in the volumetric capture system 100, which is designated in the format of "days:hours:minutes:seconds.frame number." In the present embodiment, an image capturing rate of the volumetric capture system 100 is 59.94 FPS (frames per second); however, it is not limited to this value.

Note that, the multiple images obtained by the above-described synchronized image capturing are referred to as a multi-viewpoint image. The multi-viewpoint image in the present embodiment may be an image-captured image or may be an image obtained by performing image processing such as extraction processing of a predetermined region on the image-captured image.

The multiple sensor systems 101 may include a not-illustrated microphone in addition to the camera. The microphone of each of the multiple sensor systems 101 collects the sound in synchronization with each other. Based on the collected sound, it is possible to generate an acoustic signal that is reproduced while displaying the virtual viewpoint image, which is described later. Hereinafter, for the sake of simplifying the description, description about the acoustics is omitted in some cases; however, basically, the image and the acoustic data are processed together.

The image recording apparatus 102 obtains the multi-viewpoint image from the multiple sensor systems 101 and saves the multi-viewpoint image into the database 104 with the timecode used for the image capturing.

The generation apparatus 103 obtains the multi-viewpoint image from the database 104 and generates the three-dimensional shape data representing the three-dimensional shape of the object, which is the person and the like included in the multi-viewpoint image, and the acoustic data. Note that, the three-dimensional shape data of the object is also referred to as the 3D model.

To be specific, from the multi-viewpoint image, the generation apparatus 103 obtains a foreground image, which is obtained by extracting a region corresponding to a foreground region including an image of the object that can be a foreground such as a natural person or a ball in the multi-viewpoint image, and a background image, which is obtained by extracting a region corresponding to a background region that is other than the foreground region. The foreground image and the background image include texture information such as color information. Additionally, the object that can be the foreground is, for example, a dynamic body object that has movement and the absolute position, the shape, or the like of the object may be changed in a case where the image capturing is performed from the same direction over time. To be specific, for example, the object that can be the foreground is the natural person such as a player or a referee existing in the image capturing region 120 and the body such as the ball used for a ball sport and the like. Additionally, in a case where the image capturing target is the concert, entertainment, and the like, the object that can be the foreground is the natural person such as a singer, a musician, a performer, or a master of ceremony, and the body and the like held by the corresponding natural person.

On the other hand, the object included as the image in the background region, that is, the object that can be the background is, for example, the object that is continuously in a stationary state or a substantially stationary state in a case where the image capturing is performed from the same direction over time. To be specific, for example, the object that can be the background is a structure such as the stage of the concert and the like, a playing field where an event such as a competition is held, and a goal used for ball sports, and a floor surface such as the field. Note that, the background region is a region that is at least different from the foreground region including the image of the object as the foreground. Note that, the image capturing target may include another object and the like in addition to the object that can be the foreground and the background. Based on the obtained multiple foreground images, the generation apparatus 103 generates the 3D model representing the three-dimensional shape of the foreground (a foreground model) and texture data for coloring the 3D model for each object. Additionally, the generation apparatus 103 uses the background image to generate texture data for a background model for coloring the background model representing the three-dimensional shape of the object as the background such as the playing field. The above-described 3D model is generated by using a shape estimation method such as Visual Hull and formed of point cloud and the like, for example. Note that, the generation method of the 3D model is not limited thereto, and a data format of the 3D model for each object is not limited to the point cloud and may be mesh or the like.

The generation apparatus 103 saves the 3D model including the texture data and the acoustic data into the database 104 as the volumetric data, which is material data. Details of a configuration of the database into which the above data is saved is described with reference to FIGS. 2A to 2E. Note that, the generation apparatus 103 may save the background model and the texture data for the background model into the database 104.

The uploader 105 reads out the volumetric data from the database 104 in units of timecodes and uploads the volumetric data to the distribution system 400. Details of the upload processing are described with reference to FIG. 8A. Note that, the uploader 105 may read out the texture data for coloring the background model and the background model in units of timecodes with the volumetric data from the database 104 and may upload the read data to the distribution system 400. Additionally, the uploader 105 may read out the background model and the texture data for the background model from the database 104 and upload the read data to the distribution system 400 in advance.

### Database

The database into which the volumetric data is saved is described with reference to FIGS. 2A to 2E. FIG. 2A is a diagram illustrating a volumetric data table example. A volumetric data table 200 is a table in the database into which the volumetric data including the 3D model generated by the volumetric capture system 100 is saved. The volumetric data table 200 manages timecode 201 and volumetric data 202 in association with each other.

In the volumetric data table 200, the volumetric data 202 is saved in units of frames of the timecode 201. For example, a record is saved every time a frame number is counted up in the format of the timecode "days:hours:minutes:seconds.frame number." In a case where an image capturing frame rate of the volumetric capture system 100 is 59.94 FPS, for example, the volumetric data 202 is saved as the record at an interval of about 16.667 milliseconds.

For example, in the sixth row of the volumetric data table 200, the volumetric data "Data 1A226730" generated by the volumetric capture system 100 is saved as the record of the timecode "19:01:02.034."

### Data Configuration of One Frame

FIG. 2B is a diagram illustrating a configuration example of the volumetric data of one frame. As illustrated in FIG. 2B, volumetric data 210 includes data 212 corresponding to item 211. The volumetric data 210 is formed of DataP_t 2121, which is the data corresponding to 3D model 2111, and DataA_t 2122, which is the data corresponding to acoustic data 2112.

The 3D model 2111 is the DataP_t 2121 including three-dimensional coordinates of the whole point cloud of the 3D model representing the three-dimensional shape of the foreground and the texture for coloring the 3D model. Note that, although multiple objects are treated as a single piece of the volumetric data for the sake of simplifying the description, different data may be saved for each object.

The acoustic data 2112 is, for example, the DataA_t 2122 created by using an already-existing tool and represented by a commonly-known file format typified by an RIFF waveform Audio Format (WAV) and the like. In a case of sports, the acoustic data 2112 may be the sounds from the player, the ball, or an audience collected and converted into data.

### 3D Model

Next, a 3D model example is described with reference to FIG. 2C. The 3D model is included in the volumetric data 202 saved in the volumetric data table 200. FIG. 2C is a diagram illustrating an example of generating the 3D model from the object existing in a part of the image capturing region 120 that is the image capturing target of the volumetric capture system 100. In reality, the 3D models regarding all the persons and bodies existing on the entire surface of the field as the image capturing region 120 are generated and saved into the volumetric data table 200. In this case, for the sake of simplifying the description, a part of the image capturing region 120 is focused and described.

FIG. 2C illustrates a scene example of a part of the image capturing region 120 where players 221 to 223 as the object are playing rugby, and an offload pass of a ball 224 is performed. As illustrated in FIG. 2C, in a case of using a volumetric capture technique, it is possible to reflect the shape and the positional relationship in the real space directly to the whole point cloud of the 3D model.

The volumetric data including the 3D model as illustrated in FIG. 2C is saved in the volumetric data table 200 in units of timecodes. With designation of an arbitrary timecode, it is possible to read out the 3D model of the object that is image-captured at the timecode from the volumetric data table 200 (the database 104).

The above-described volumetric data table 200 is prepared for each distribution event. The distribution event is applied with an identifier, and the identifier applied to the distribution event is called a distribution event ID.

### Distribution Event ID Table

FIG. 2D is a diagram illustrating a distribution event ID table example. A distribution event ID table 230 manages an ID indicated in distribution event ID 231 and information indicated in each of volumetric table ID 232, distribution event information 233, and connection configuration information 234 in association with each other.

In a case of "2001" of the distribution event ID 231, the following pieces of information are managed in association with each other. To be specific, "VolumetricTable201" of the volumetric table ID 232, "EventData2001" of the distribution event information 233, and "ConnectTree2001" of the connection configuration information 234 are managed in association with each other. In this case, for the sake of simplifying the description, VolumetricTable201 is the volumetric data table 200 illustrated in FIG. 2A.

Likewise, in a case of "200N" of the distribution event ID 231, the following pieces of information are managed in association with each other. To be specific, "VolumetricTable20N" of the volumetric table ID 232, "EventData200N" of the distribution event information 233, "ConnectTree200N" of the connection configuration information 234 are managed in association with each other.

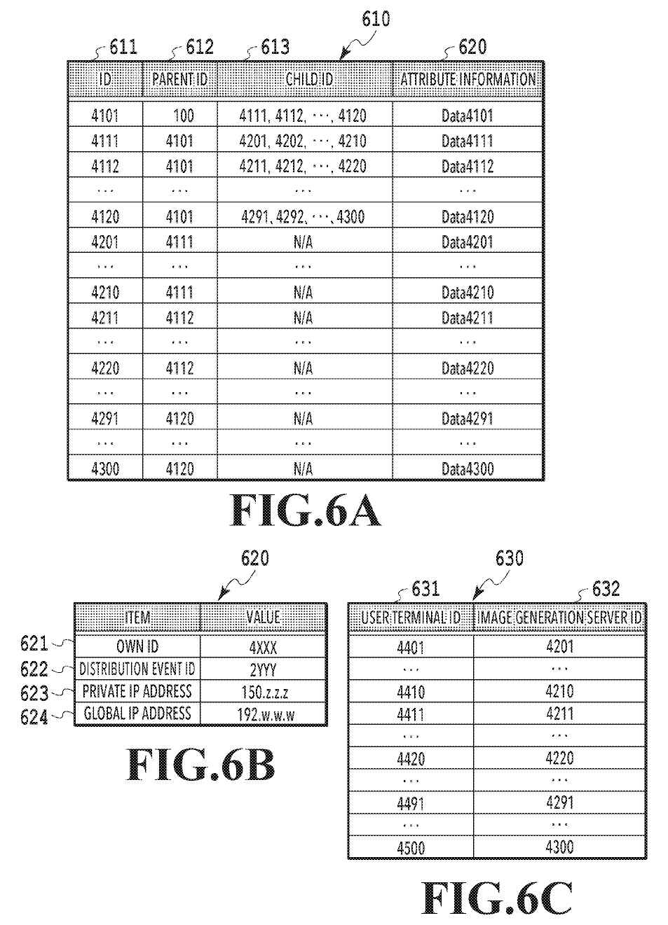

That is, once the distribution event ID is designated, it is possible to refer to each piece of information of the volumetric data table ID, the distribution event information, and the connection configuration information managed in association with the designated distribution event ID by using the distribution event ID table 230. Note that, details of the distribution event information are described with reference to FIG. 5, and details of the connection configuration information are described with reference to FIGS. 6A to 6C.

The uploader 105 refers to the volumetric data table 200 by designating the distribution event ID, designates the timecode in the volumetric data table 200, and reads out the volumetric data associated with the timecode. Then, the uploader 105 updates the timecode to read out the volumetric data and uploads the volumetric data to the distribution system 400 as needed. Details of the upload processing are described with reference to FIG. 8A.

### Setting of Virtual Viewpoint

Subsequently, the virtual viewpoint set by each user is described using a case where the rugby game at the stadium is assumed as the image capturing scene as an example. First, a coordinate system representing a three-dimensional space of the image capturing target that is a reference in a case of setting the virtual viewpoint is described.

The coordinate system and the like to set the virtual camera 140N (the virtual camera group 1400) are described with reference to FIGS. 3A to 3D and FIG. 1C. The virtual camera 140N is designated by using a single coordinate system.

FIG. 3A is a diagram illustrating a Cartesian coordinate system representing the three-dimensional space with three axes, which are an X axis, a Y axis, and a Z axis, that is used in the present embodiment. In the Cartesian coordinate system, a unit of meters is used, for example.

The Cartesian coordinate system is set to the object as the image capturing target that is, for example, the field in the stadium illustrated in FIG. 1C, a studio, and the like. As illustrated in FIG. 3B, the image capturing target includes the entire field in the stadium that is the image capturing region 120, the player, and the body and the like such as the ball existing on the field. Note that, the object may include an audience seat and the like around the field.

To be specific, first, an origin (0, 0, 0) is set at the center of the ground as the image capturing region 120. Additionally, the X axis is set in a long side direction of the ground, the Y axis is set in a short side direction of the ground, and the Z axis is set in a vertical direction with respect to the stage. Note that, the direction of each axis is not limited thereto. The above-described coordinate system is used to designate the position and the orientation of the virtual camera.

Next, the virtual camera is described with reference to FIGS. 3C and 3D. The virtual camera (or the virtual viewpoint) is a viewpoint to draw the virtual viewpoint image.

In a square pyramid 300 illustrated in FIG. 3C, a vertex 301 represents the position of the virtual camera, and a vector 302 starting from the vertex 301 in a line-of-sight direction represents the orientation (the direction) of the virtual camera. The position of the virtual camera is expressed by a component of each axis (x, y, z), and the orientation of the virtual camera is expressed in units of vectors with the component of each axis as a scalar. The vector 302 representing the orientation of the virtual camera passes through the center point of a front clip surface 303 and a back clip surface 304. A frustum of the virtual viewpoint that is a projection range (drawing range) of the three-dimensional model is a space 305 sandwiched by the front clip surface 303 and the back clip surface 304. Note that, the vector 302 representing the orientation of the virtual camera is also called an optical axis vector of the virtual camera.

Next, movement (change in the position of the virtual camera) and rotation (change in the orientation of the virtual camera) of the virtual viewpoint are described.

It is possible to move and rotate the virtual viewpoint in the space expressed by the three-dimensional coordinate. FIG. 3D is a diagram describing the movement of the virtual viewpoint. In FIG. 3D, an arrow 311 of a broken line represents the movement of the virtual viewpoint, and an arrow 312 of a broken line represents the rotation of the moved virtual viewpoint. The movement of the virtual viewpoint is expressed by the component of each axis (x, y, z), and the rotation of the virtual viewpoint is expressed by Yaw that is rotation about the Z axis, Pitch that is rotation about the X axis, and Roll that is rotation about the Y axis. The movement and the rotation of the virtual viewpoint described above are used to maneuver the virtual camera by manipulation by the user.

As described above, with designation of the X, Y, and Z coordinates (x, y, z) and the rotation angles of the X axis, the Y axis, and the Z axis (Pitch, Roll, and Yaw) of the virtual camera, it is possible to manipulate the image capturing position and the direction of the virtual camera with no restriction. Note that, the operation of the virtual camera is not limited to the above, and any operation may be applied as long as it is possible to implement the operation by a combination of the movement and the rotation of the virtual camera.

With the above-described operation, the virtual camera can be manipulated to arbitrary position and orientation. Thus, the virtual camera can be moved and rotated with no restriction in the three-dimensional virtual space in which the 3D model generated from the object is arranged, and an arbitrary region of the virtual space can be generated as the virtual viewpoint image.

The information related to the position and the orientation of the virtual camera is hereinafter referred to as the virtual camera information. Note that, the information included in the virtual camera information may include a focal length and the like in addition to the position and the orientation.

Note that, although only one virtual camera 140N is illustrated in FIG. 1C, in reality, as illustrated in FIG. 1A, a different virtual camera group 1400 is prepared for each user terminal 4400. In each user terminal 4400, manipulation on each virtual camera 1400 is accepted independently. Each virtual camera of the virtual camera group 1400 is set within the virtual space associated with the image capturing region 120, and it is possible to browse the virtual space from a viewpoint different from that of any of the cameras included in the multiple sensor systems 101.

### Distribution System

FIG. 4 is a diagram describing a configuration of the distribution system 400.

The distribution system 400 is structured on a cloud platform. The distribution system 400 reads out the volumetric data to the virtual space arranged in advance, generates the virtual viewpoint image based on the virtual camera information obtained from the user terminal, and provides the generated virtual viewpoint image to each user terminal 4400. The virtual space is arranged based on the background model and the texture data for the background model that are uploaded from the volumetric capture system 100 and the like and saved in the virtual server in advance. The volumetric data is uploaded from the volumetric capture system 100 at each timecode. The volumetric data is provided to each user terminal 4400 that transmits the virtual camera information used to generate the virtual viewpoint image.

The distribution system 400 includes a connection configuration management server 401, a data transfer server group 4100, an image generation server group 4200 and a not-illustrated user authentication server. Note that, these server groups are servers structured on the cloud platform (hereinafter, also referred to as a cloud). The data transfer server group 4100 and the image generation server group 4200 are activated and terminated for every distribution event, and the connection configuration management server 401 and the user authentication server are servers that are activated constantly. Details of the user authentication server are described later.

The data transfer server group (transmission server group) 4100 is a collective term for multiple data transfer servers (transmission servers). A single data transfer server is structured as a single virtual server on the cloud platform. In a case of indicating a single arbitrary data transfer server included in the data transfer server group 4100, it is written as a data transfer server 410N.

Likewise, the image generation server group 4200 is a collective term for multiple image generation servers. A single image generation server is structured as a single virtual server on the cloud platform. In a case of indicating a single arbitrary image generation server included in the image generation server group 4200, it is written as an image generation server 420N.

Note that, the data transfer server group 4100 and the image generation server group 4200 may be collectively called as a virtual server group, and in a case of indicating a single arbitrary server thereof, it may be written as a virtual server.

The user terminal group 4400 is a tablet, a smartphone, or the like held by the user, and each can manipulate a different virtual camera group 1400 independently. Additionally, the corresponding user terminal group transmits the virtual camera information of the manipulated virtual camera group 1400 to the image generation server group 4200. Since the details of the virtual camera are described with reference to FIGS. 3A to 3D, description herein is omitted. Details of processing related to the user terminal group 4400 and the virtual camera group 1400 are described with reference to FIG. 10 and FIGS. 11A to 11F.

In the present system, the data is transferred from the volumetric capture system 100 to the image generation server group 4200 via the data transfer server group 4100. In other words, the data transfer server group 4100 plays a role to transfer the volumetric data received from the volumetric capture system 100 to the image generation server group 4200. Hereinafter, an upstream of the data flow may be written as a transmission source, and a downstream thereof may be written as a transmission destination.

The data transfer server group 4100 and the image generation server group 4200 are connected to each other by using a configuration of a tree structure. In the present embodiment, this is referred to as the distribution connection configuration. The capability of structuring the distribution connection configuration and providing the manipulation of the virtual camera and the virtual viewpoint image to the corresponding user terminal 4400 is the characteristic, and in order to describe the characteristic, an overview of each element is described first.

The data transfer server group 4100 transfers the volumetric data including the 3D model and the acoustic data that is generated from the image-captured image of the object in the volumetric capture system 100 to the image generation server group 4200. The data transfer server group 4100 performs only data transfer without processing the data (the image processing and the like).

The image generation server group 4200 receives the virtual camera information from each user terminal 4400. Then, the image generation server group 4200 generates the virtual viewpoint image by rendering the volumetric data and the background model and the texture data for the background model uploaded in advance from each viewpoint and transmits the virtual viewpoint image to each user terminal 4400.

The connection configuration management server 401 manages the structuring of the distribution connection configuration of the data transfer server group 4100 and the image generation server group 4200 and the association between the image generation server group 4200 and the user terminal group 4400. As described later in detail, it is possible to call the connection configuration management server 401 also as a setting server since it is a server that sets a server operating as the transmission server and a server operating as the image generation server. Additionally, the connection configuration management server 401 manages also the distribution event ID and the corresponding distribution event information.

The user authentication server performs authentication processing of the user terminal group 4400. The user authentication server allows only the authenticated user terminal to connect to the image generation server.

### Structuring Processing of Distribution Connection Configuration

The structuring processing of the distribution connection configuration in the distribution system 400 is described. The structuring processing of the distribution connection configuration has substantially the same meaning as structuring the distribution system 400 itself, and the structuring processing of the distribution connection configuration is also referred to as structuring processing of the distribution system.

The distribution system 400 is structured for every distribution event. The distribution event indicates, for example, one game of the professional sports, one live performance event of the artist, or the like. The distribution event is applied with the identifier for each distribution event, which is managed as the distribution event ID. Since the details of the distribution event ID table 230 managing the distribution event ID are described with reference to FIG. 2D, description herein is omitted.

Note that, the distribution event ID table 230 may be managed by the database 104 of the volumetric capture system 100 or may be managed by the connection configuration management server 401 of the distribution system 400.

The distribution system 400 of the present embodiment is structured on the cloud platform with the distribution event and deleted from the cloud in a case where the event ends.

Note that, the data transfer server group 4100 and the image generation server group 4200 are generated and terminated for each distribution event, and the connection configuration management server 401 and the not-illustrated user authentication server are activated constantly.

Additionally, in the present embodiment, for the sake of simplifying the description of the distribution connection configuration, a one-to-one configuration in which a single user terminal (440N) is connected to a single image generation server (420N) is applied. In other words, the branching number of the image generation server group 4200 that is a leaf node in the tree structure is equal to an upper limitation of the number of the user terminals. For example, in a case where the upper limitation of the number of the user terminals is 100, 100 image generation servers are structured. Note that, as a matter of course, the above-described connection configuration is not limited to one-to-one, and the number of the user terminals is not limited to 100.

### Structuring Processing of Distribution Connection Configuration (Distribution System)

FIG. 5 is a flowchart illustrating a flow of the structuring processing of the distribution connection configuration (the distribution system). The present processing is executed with the connection configuration management server 401 mainly performing overall control on also the other servers in the distribution system 400.

In S501, the connection configuration management server 401 accepts the distribution event information. The distribution event information is information related to the distribution event for each distribution event and is information required to structure the distribution system. The distribution event information is described with reference to FIG. 2E. As illustrated in FIG. 2E, distribution event information 240 is formed of item 241 described as follows and value 242 thereof. In the item 241, distribution event ID 2411, volumetric data bandwidth upper limitation 2412, user terminal number upper limitation 2413, and transfer server input-output data bandwidth upper limitation 2414 are designated.

The distribution event ID 2411 indicates the identifier applied to the distribution event. The volumetric data bandwidth upper limitation 2412 indicates data amount information that is second information indicating the maximum data amount of the volumetric data inputted to the distribution system 400. The user terminal number upper limitation 2413 indicates the upper limitation of the number of the user terminals to which the multiple virtual viewpoint images of different viewpoints that are generated simultaneously are distributed in a case where the user terminals are connected to the image generation servers on the one-to-one basis. It can be said also that the user terminal number upper limitation 2413 indicates number information that is third information indicating the number of the servers operating as the image generation servers in a case where the user terminals are connected to the image generation servers on the one-to-one basis. The transfer server input-output data bandwidth upper limitation 2414 indicates transmittable data amount information that is first information indicating the data amount of transmittable data per unit time in the server operating as the transfer server. Additionally, in the item 241, event starting clock time 2415, event ending clock time 2416, ticket selling ending clock time 2417, and the like are designated. Details of the pieces of information 2411 to 2417 are described later. Note that, the distribution event information 240 is not limited to those pieces of information 2411 to 2417 and may include any information as long as it is information required to structure the distribution event or the distribution system. The distribution event information may be automatically obtained from the system or may be manually inputted by a manager. The connection configuration management server 401 can apply the distribution event ID to the accepted distribution event information and can save and refer to the distribution event information as needed.

In S502, the connection configuration management server 401 obtains the bandwidth upper limitation of the volumetric data to be uploaded by the volumetric capture system 100 from the distribution event information obtained in S501. The data bandwidth upper limitation is the total of the upper limitation values of the data amount of the 3D model of the object, the data amount of the acoustic data, and the like and indicates the data amount information indicating the maximum data amount of the material data that can be inputted to the distribution system 400. In this case, as an example, 5 Gbps indicated by the data associated with the volumetric data bandwidth upper limitation 2412 is obtained. Note that, as a matter of course, the data bandwidth upper limitation is not limited to 5 Gbps and may be according to a variation of the number of the persons and the bodies as the object for each distribution event. For example, in the rugby game, the data bandwidth upper limitation may be changed according to the number of the objects (the player, the referee, the ball, and a goal post) that may exist on the field as the image capturing target. Additionally, in the game of baseball, soccer, American football, basket ball, and the like, the data bandwidth upper limitation may also be changed according to the number of the objects (the player, the referee, the ball, and the like) that may exist on the field as the image capturing target, as with a case of the rugby game. That is, the data bandwidth upper limitation of the volumetric data is determined according to the number of the objects. The data bandwidth upper limitation of the volumetric data may be determined to be great in a case where the number of the objects is great and to be small in a case where the number of the objects is small.

In S503, the connection configuration management server 401 obtains the transfer server input-output data bandwidth upper limitation from the distribution event information. The transfer server input-output data bandwidth upper limitation indicates the transmittable data amount information indicating the data amount of the transmittable data per unit time in the server operating as the transfer server. In this case, as an example, 55 Gbps or the like indicated by the data associated with the transfer server input-output data bandwidth upper limitation 2414 is obtained. Note that, as a matter of course, the virtual server input-output data bandwidth upper limitation is not limited to this value, and a type of the virtual server may be changed, and the input-output data bandwidth upper limitation may be changed for each distribution event according to the bandwidth upper limitation of the volumetric data obtained in S502.

In S504, the connection configuration management server 401 obtains the upper limitation number of the user terminals from the distribution event information. Since the user terminals are connected with the image generation servers, it is also possible to say that the upper limitation number of the user terminals indicates number information indicating the number of the servers operating as the image generation servers. In this case, as an example, 100 indicated by the data associated with the user terminal number upper limitation 2413 is obtained. Note that, the upper limitation number of the user terminals is not limited to this value and may be changed for each distribution event.

In S505, the connection configuration management server 401 determines the distribution connection configuration (the branching number of the tree structure) from the information obtained until S504. In the determination processing of the distribution connection configuration (the tree structure), the tree structure as illustrated in FIG. 4 that provides the virtual viewpoint image to the upper limitation number Un of the of the user terminals designated until S504 is determined. In other words, it is processing of obtaining a branching number In of the image generation server group 4200, a depth (the number of stages) Td in the tree structure of the data transfer server group 4100, and a branching number Tn of the data transfer server group 4100 for each depth from the upper limitation number Un of the user terminals.

Note that, there are various algorithms to determine the tree structure as described above including a greedy algorithm; for this reason, detailed description is omitted, and the point of the determination processing of the distribution connection configuration is described sequentially according to the example in FIG. 4.

First, the connection configuration management server 401 obtains the branching number In of the image generation server group 4200. In the present embodiment, since the configuration in which the user terminals and the image generation servers are connected to each other on the one-to-one basis is applied, the branching number In is obtained simply based on In = Un. Note that, a configuration in which the image generation servers and the user terminals are connected to each other on a one-to-multiple (N) basis. Also in this case, the branching number In is obtained simply based on In = Un/N. As an example in this case, since 100 is obtained as the upper limitation number of the user terminals until S504, the branching number of the image generation servers is 100.

Subsequently, the connection configuration management server 401 obtains the upper limitation number Sn of the virtual servers connectable to a single data transfer server. In a case where the virtual server data input-output bandwidth is Sd, and the upper limitation of the bandwidth of the volumetric data is Vd, the connection configuration management server 401 can obtain the upper limitation number Sn of the virtual servers connectable to a single data transfer server by solving Sn = Sd/Vd. The connectable upper limitation number Sn is the number of a sum of parent nodes and child nodes, and since there is a single parent node in the tree structure, the upper limitation number Scn of the connectable child node is obtained by solving Scn = Sn - 1.

In the example, until S504, Sd = 55 Gbps is obtained as the virtual server data input-output bandwidth, and Vd = 5 Gbps is obtained as the bandwidth upper limitation of the volumetric data. Therefore, the upper limitation number Sn of the virtual servers connectable to a single data transfer server is Sn = Sd/Vd = 55 Gbps/5 Gbps = 11. Additionally, the upper limitation number Scn of the connectable child nodes is Scn = Sn - 1 = 11 - 1 = 10.

In the present embodiment, the data transfer servers having the same specification are connected to each other recursively in the tree structure. Therefore, a relationship Scn^Td ≥ In is established between the branching number In of the image generation server group 4200 as a terminal node in the tree structure, the upper limitation number Scn of the child nodes connectable to a single data transfer server, and the depth Td of the data transfer server group 4100 in the tree structure. In this case, the relationship is obtained such that Td is the minimum depth.

In the example, 10^Td ≥ 100 is obtained, the minimum Td = 2 is obtained, and the depth of the data transfer server is 2. That is, in a case where the depth of the root node is 1, with a configuration including the depth of 2 (stages), the data transfer servers can cover 100 image generation servers.

Finally, with use of the value obtained as above, the branching number Tn of the data transfer server group 4100 may be determined based on the rounded-down number of (the number of the child nodes at the corresponding stage)/Scn sequentially from a deeper stage of the tree structure.

In the example, as for the child nodes connected to the deepest stage number Td = 2, the branching number thereof is obtained as In in the image generation server group 4200. Therefore, the number T2 of the data transfer servers at the second stage that is required for the image generation server group 4200 is T2 = In/Scn = 10. In addition, a root node T1 at the first stage is T1 = 10/Scn = 10/10 = 1.

As a result, as illustrated in FIG. 4, there is a single data transfer server 4101 positioned at a root of the tree structure, and there are 10 data transfer servers 4111 to 4120 at the second stage in a position of an intermediate node connected to the data transfer server (data transmission server) 4101 at the root. Accordingly, a configuration in which each data transfer server at the second stage is connected to 10 image generation servers is applied. For example, the data transfer server 4111 is connected to 10 image generation servers 4201 to 4210, and the data transfer server 4120 is connected to 10 image generation servers 4291 to 4300.

Note that, for the sake of simplifying the description, although an example in which the branching number of the data transfer server at each stage is equal to the upper limitation number Scn of the child nodes connectable to a single data transfer server (an example in which the rounded-down number of the number of child nodes at the corresponding stage/Scn is divisible) is described, as a matter of course, it is not limited to the example. As for the data transfer server at each stage, the number of the connected child nodes may not reach the upper limitation number Scn.

As described above, the distribution connection configuration is determined with variables of the virtual server data input-output bandwidth Sd, the volumetric data bandwidth upper limitation Vd, and the number In of the user terminals. In other words, even in a case where these values are changed for each distribution event, the present processing is automatically executed.

### Distribution Connection Configuration Management Table

FIGS. 6A to 6C are diagrams illustrating various tables saving the distribution connection configuration. FIG. 6A illustrates a table 610 managing the connection configuration of the tree structure of the data transfer server group 4100 and the image generation server group 4200. FIG. 6B illustrates attribute information 620 related to the virtual server of the concerned ID. FIG. 6C illustrates a table 630 managing the connection configuration of the image generation server group 4200 and the user terminal group 4400.

The table 610 includes ID 611, parent ID 612, child ID 613, the attribute information 620 as items in a horizontal axis. The ID 611 is an identifier of the virtual server such as the data transfer server 410N and the image generation server 420N. In this case, for the sake of simplifying the description, the value of the ID is the same as the ID illustrated in FIG. 4. For example, ID = 4101 indicates the data transfer server 4101 in FIG. 4.

As the parent ID 612, a virtual server ID (a parent node ID) corresponding to the parent node of the concerned ID in the tree structure (the distribution connection configuration) is stored. For example, in the second row of the table 610, ID = 4111, and parent ID = 4101. This indicates that the parent node of the data transfer server 4111 is the data transfer server 4101 as the distribution connection configuration illustrated in FIG. 4.

Additionally, as the child ID 613, a virtual server ID (a child node ID) corresponding to the child node of the concerned ID in the tree structure (the distribution connection configuration) is stored. Note that, in some cases, multiple IDs of the child nodes may be stored. For example, in the second row of the table 610, ID = 4111, and child IDs = 4201, 4202, ..., 4210 are stored. This indicates that the child nodes of the data transfer server 4111 are 10 image generation servers 4201 to 4210 as the distribution connection configuration illustrated in FIG. 4.

From the perspective of the virtual server of the concerned ID, the parent ID can be written also as a data transmission source, and the child ID can be written also as a data transmission destination. Hereinafter, the descriptions, a transmission source and a transmission destination, may be used.

In the preceding example, in the second row of the table 610, from the perspective of the data transfer server of the concerned ID = 4111, the data transmission source is 4101 of the parent ID, and the transmission destinations are 4201 to 4210 of the child IDs.

As the attribute information 620, attribute information related to the virtual server of the concerned ID is stored. Items of the attribute information 620 are own ID 621, distribution event ID 622, private IP address 623, global IP address 624, and the like.

The own ID (or simply an ID) 621 is an own virtual server identifier. In the example of the distribution system in FIG. 4, the own ID is 4101, 4111 to 4120, 4201 to 4300, or the like.

The distribution event ID 622 is the distribution event ID to which the own ID 621 belongs. Note that, since the details of the distribution event ID 622 are described with reference to FIGS. 2A to 2E, description herein is omitted.

The private IP address 623 is an IP address used for communication in the cloud platform. The private IP address 623 is used for data transmission and reception in the data transfer server group 4100 and data transmission and reception between the data transfer server 410N and the image generation server 420N, for example.

The global IP address 624 is an IP address used for communication with the outside of the cloud platform. The global IP address 624 is used for data transmission and reception between the image generation server 420N and the user terminal 440N, for example.

Note that, the attribute information may include information other than the information related to the own ID 621, the distribution event ID 622, the private IP address 623, and the global IP address 624 as long as it is information related to the virtual server.

The attribute information 620 can be obtained from the connection configuration management server 401 by designating an arbitrary ID. For example, with reference to the attribute information of the parent ID, it is possible to obtain the IP address of the parent node, and with reference to the attribute information of the child ID, it is possible to obtain the IP address of the child node.

The table 630 includes user terminal ID 631 and image generation server ID 632 as items in the horizontal axis. Thus, the association between the user terminal ID 631 and the image generation server ID 632 is managed as the connection configuration. For example, with reference to the first row of the table 630, it can be seen that user terminal ID 631 = 4401 is associated with image generation server ID 632 = 4201. In a case where a global IP is obtained from the attribute information of image generation server ID 632 = 4201, the user terminal 4401 can be connected with the image generation server 4201.

Similar processing is performed on all the other user terminals in the table 630, and it is possible to establish the connection between the concerned user terminal and the associated image generation server. Details of the above-described processing on the user terminal are described with reference to FIG. 10. Note that, a timing at which the user terminal group 4400 and the image generation server group 4200 in the table 630 are associated with each other is also described with reference to FIG. 10.

The above-described table 610, table 630, and each attribute information 620 are collectively referred to as connection configuration information 600 (600 is not illustrated).

With reference to the connection configuration information 600, the attribute information related to all the virtual server IDs is stored, and it is possible to obtain the IP address and the like as a network address of the parent node (the transmission source) and the child node (the transmission destination) from an arbitrary ID.

The connection configuration management server 401 provide the attribute information to each virtual server and the user terminal group as the connection configuration information 600. In other words, all the data transfer server 410N, image generation server 420N, and user terminal 440N recognize the IP address of the connection destination based on the connection configuration information 600 obtained from the connection configuration management server 401, and it is possible to establish the connection according to the connection configuration information.

Additionally, the attribute information of the concerned server is written into a ROM 733 and the like in a case of generating the virtual server and can be obtained at an arbitrary timing without inquiring of the connection configuration management server 401.

Note that, as the parent ID of the virtual server (the data transfer server 4101) at the root of the tree structure, 100 that is the ID of the volumetric capture as illustrated in the second row of the table 610 is stored. Thus, the data transfer server 4101 can be connected to the volumetric capture system 100 and receive the data.

The connection configuration management server 401 applies an identifier to the above-described connection configuration information 600 and manages the connection configuration information 600 in the distribution event ID table with the distribution event ID. As illustrated in FIG. 2D, in this case, connection configuration information "ConnectTree2001" is managed in association with distribution event ID = 2001. As illustrated in FIG. 2D, as for distribution event ID = 2001, volumetric table ID = "VolumetricTable201" and distribution event information "EventData2001" are managed in association with each other.

That is, with designation of the distribution event ID, it is possible to access the volumetric data of an arbitrary timecode and to access the network addresses of an arbitrary virtual server and user terminal included in the connection configuration information.

Referring back to FIG. 5, the processing in and after S506 is described. In S506, the connection configuration management server 401 determines whether the current clock time is event starting clock time designated by the distribution event information. If a reaching of the event starting clock time is not detected, and it is determined that the current clock time is not the event starting clock time (NO in S506), the processing in S506 is executed again. That is, the processing stands by until the current clock time reaches the event starting clock time. If the reaching of the event starting clock time is detected, and it is determined that the current clock time is the event starting clock time (YES in S506), the processing proceeds to S507.

In S507, the connection configuration management server 401 executes activation control to activate the data transfer server group 4100 of the designated branching number based on the distribution connection configuration determined until S506. Note that, in a case of activating the data transfer server group 4100, the distribution event ID may be written into the corresponding ROM 733 and the like.

In S508, the connection configuration management server 401 executes activation control to activate the image generation server group 4200 of the designated branching number based on the distribution connection configuration determined until S507. Note that, in a case of activating the image generation server group 4200, the distribution event ID may be written into the corresponding ROM 733 and the like.

In S509, the connection configuration management server 401 obtains the corresponding IP address of the data transfer server group 4100 and the image generation server group 4200 activated until S508. This is because it is common for the IP address of the virtual server on the cloud platform to be determined after activation. All the obtained IP addresses are saved into the connection configuration information 600. Since the details of the connection configuration information 600 are described above, description herein is omitted.

In S510, the connection configuration management server 401 activates each server application in the data transfer server group 4100 and the image generation server group 4200. Each server application obtains the connection configuration information 600 from the connection configuration management server 401 and establishes the connection between the transmission source and the transmission destination according to the distribution connection configuration (the tree structure).

The server application is software that executes each processing in each virtual server. Note that, details of the server application are described with reference to FIGS. 7A to 7C.

At this point, the structuring processing of the distribution connection configuration is completed, and the distribution system 400 is in an upload standby state of the volumetric data from the volumetric capture system 100. Additionally, the distribution system is also in a connection standby state from each user terminal.

In S511, the distribution system 400 executes distribution processing of the virtual viewpoint image. Details of transfer processing of the volumetric data, generation processing of the virtual viewpoint image, and the like included in the distribution processing are described with reference to FIGS. 8A to 8C.

In S512, the connection configuration management server 401 determines whether the current clock time is distribution ending clock time designated in the distribution event information. If it is determined that the current clock time is not the distribution ending clock time (NO in S512), the processing in S512 is executed again. That is, the processing stands by until the current clock time reaches the distribution ending clock time. If it is determined that the current clock time is the distribution ending clock time (YES in S512), the processing proceeds to S513.

In S513, the connection configuration management server 401 stops all the server applications. In S514, the connection configuration management server 401 deletes the distribution system 400.

As described above, with use of the connection configuration information according to the present embodiment, it is possible to structure the connection configuration in which the volumetric data generated by the volumetric capture system 100 is transmitted to each image generation server of the image generation server group 4200 in the distribution system 400.

In addition, in each image generation server, it is possible to structure the distribution connection configuration in which the virtual camera 1400 manipulated independently by each user terminal 4400 is received and the virtual viewpoint image is generated and provided by using the above-described volumetric data and each virtual camera.

### Functional Configuration of Data Transfer Server

First, a configuration of the data transfer server that is one of the virtual servers is described. FIG. 7A is a diagram illustrating a functional configuration example of the data transfer server 410N. As illustrated in FIG. 7A, the data transfer server 410N includes a data transfer control unit 711, a connection configuration obtainment unit 712, a data reception unit 713, and a data transmission unit 714. Note that, software that executes the above functions in the data transfer server 410N is also written as the server application.

The data transfer server 410N uses the function illustrated in FIG. 7A to transfer the volumetric data uploaded from the volumetric capture system 100 to the image generation server 420N. The volumetric data includes the 3D model, the acoustic data, the control data, and the like. The control data is, for example, data that is used to update the background model such as day-and-night setting.

The data transfer control unit 711 performs overall control of the data transfer server 410N including a functional unit other than the data transfer control unit 711 and executes processing of transferring the received data to the transmission destination according to the connection configuration. The connection configuration obtainment unit 712 obtains the connection configuration information from the connection configuration management server 401. Since the details of the connection configuration information are described with reference to FIGS. 6A to 6C, description herein is omitted.

The data reception unit 713 establishes the connection with the other data transfer server 410N or the volumetric capture system 100 that is the transmission source obtained from the connection configuration information and receives the volumetric data. Note that, the received data may be buffered.

The data transmission unit 714 establishes the connection with the other data transfer server 410N or the image generation server 420N that is the transmission destination obtained from the connection configuration information and transmits the volumetric data to the transmission destination with which the connection is established. Note that, details of the data transfer processing of the data transfer server 410N are described with reference to FIG. 8B.

### Functional Configuration of Image Generation Server

Subsequently, a configuration of the image generation server 420N that is one of the servers in the virtual server group is described. FIG. 7B is a diagram illustrating a functional configuration example of the image generation server 420N. As illustrated in FIG. 7B, the image generation server 420N includes a connection configuration obtainment unit 721, a data reception unit 722, a virtual camera control unit 723, an image generation unit 724, and a data transmission unit 725. Note that, software that executes the above functions in the image generation server 420N is also written as the server application.

The image generation server 420N uses the function illustrated in FIG. 7B to generate the virtual viewpoint image based on the volumetric data, the background model and the texture data for the background model, and the virtual camera information. Note that, the volumetric data is transferred from the data transfer server 410N. The background model and the texture data for the background model are uploaded in advance. The virtual camera information is transmitted from the user terminal 440N.

The image generation unit 724 performs overall control of the image generation server 420N including the functional unit other than the image generation unit 724, generates the virtual viewpoint image, and provides the virtual viewpoint image to the user terminal.

The connection configuration obtainment unit 721 obtains the connection configuration information from the connection configuration management server 401. Since the details of the connection configuration information are described with reference to FIGS. 6A to 6C, description herein is omitted. The data reception unit 722 establishes the connection with the data transfer server 410N that is the transmission source obtained from the connection configuration information and receives the volumetric data in units of timecodes.

The virtual camera control unit 723 accepts the virtual camera information from the user terminal 440N that is the transmission source obtained from the connection configuration information and updates the position and the orientation of the virtual camera and the like. Note that, since the details of the operation of the virtual camera are described with reference to FIGS. 3A to 3D, description herein is omitted.

The image generation unit 724 generates the virtual viewpoint image based on the volumetric data, the background model, the texture data for the background model, and the virtual camera information. The data transmission unit 725 transmits the generated virtual viewpoint image to the user terminal 440N that is the transmission destination obtained from the connection configuration information. Note that, details of the generation processing of the virtual viewpoint image in the image generation server 420N are described with reference to FIG. 8C.

### Hardware Configuration of Virtual Server (Data Transfer Server and Image Generation Server)

Next, a hardware configuration example of the virtual server (the data transfer server and the image generation server) is described. FIG. 7C is a diagram illustrating a hardware configuration example of the virtual server (the data transfer server 410N and the image generation server 420N). The virtual server includes the data transfer server 410N and the image generation server 420N; however, the servers basically have the same configuration, and a different point is supplementarily described as needed.

The virtual server includes a central processing unit (CPU) 731, a random access memory (RAM) 732, and the read only memory (ROM) 733. The virtual server additionally includes a solid state drive (SSD) 734, an external interface (I/F) 735, and a graphics processing unit (GPU) 736.

The CPU 731 executes processing by using a program and data stored in the RAM 732 or the ROM 733. The CPU 731 performs operation control of overall the virtual server and executes processing of implementing each function illustrated in FIGS. 7A and 7B.

The ROM 733 holds the program and the data. As a data example, the virtual server ID (or the own ID), the distribution event ID, and the like that are set in a case of generating the virtual server are held. The RAM 732 includes a working area that temporarily stores the program and the data read out from the ROM 733. Additionally, the RAM 732 provides the working area used in a case where the CPU 731 executes each processing.

The SSD 734 is used as a storage region and records the connection configuration information 600 and the like. Note that, in a case where the background model and the texture data for the background model are uploaded in advance, the SSD 734 of the image generation server 420N stores the background model and the texture data for the background model uploaded in advance.

The I/F (external interface) 735 is a transmission and reception port or the like of a network. In a case of activating the virtual server, the private IP address and the global IP address are allocated to the transmission and reception port of the virtual server. For example, the private IP address is used to perform transmission and reception of the information with the other virtual server and the connection configuration management server 401 on the cloud. Additionally, the global IP address is used to perform transmission and reception of the data with the user terminal. A network bandwidth of the external interface is commonly different for each virtual server and is, for example, 55 Gbps or the like.

The GPU 736 executes the processing of generating the virtual viewpoint image by using mainly the 3D model. Note that, out of the virtual servers, the GPU 736 is included in only the image generation server 420N and not in the data transfer server 410N.

Note that, the virtual server may include one or more pieces of dedicated hardware different from the CPU 731 and the GPU 736, and the dedicated hardware may execute at least a part of the processing executed by the CPU 731. An example of the dedicated hardware includes an application specific integrated circuits (ASIC), a field programmable gate array (FPGA), a digital signal processor (DSP), and the like.

### Distribution Processing of Virtual Viewpoint Image

The distribution processing of the virtual viewpoint image is described with reference to FIGS. 8A to 8C, FIG. 10, and FIGS. 11A to 11F. The processing mainly consists of four types of processing. The first processing is the upload processing of the volumetric data illustrated in FIG. 8A. The second processing is the data transfer processing of the data transfer server group 4100 illustrated in FIG. 8B. The third processing is the image generation processing of the image generation server group 4200 illustrated in FIG. 8C. The fourth processing is display processing of the virtual viewpoint image of the user terminal group 4400 illustrated in FIG. 10. The processing is described below sequentially.

### Upload Processing of Volumetric Data

Details of the upload processing of the volumetric data are described with reference to FIG. 8A. FIG. 8A is a flowchart illustrating a flow of the upload processing of the volumetric data. With the upload processing being executed, the volumetric data is uploaded from the volumetric capture system 100 to the distribution system 400. Note that, the present processing is executed by the uploader 105 included in the volumetric capture system 100.

In S8001, the uploader 105 accepts the distribution event ID. Since the details of the distribution event ID are described with reference to FIGS. 2A to 2E, description herein is omitted. With designation of the distribution event ID, the table 201 to be used, which is included in the database 104 of the volumetric capture system 100, is determined.

In S8002, the uploader 105 obtains the connection configuration information from the connection configuration management server 401. Since the details of the connection configuration information are described with reference to FIGS. 6A to 6C, description herein is omitted.

In S8003, the uploader 105 establishes the connection with the data transfer server 4101 of the distribution system 400 that is the transmission destination of the own ID based on the obtained connection configuration information.

In S8004 to S8007, the uploader 105 executes the following processing repeatedly. An interval of the repeated execution of the processing from S8004 to S8007 is according to the image capturing FPS of the volumetric capture system 100. In this case, the processing is repeated at 59.94 FPS described with reference to FIGS. 1A to 1C.

In S8005, the uploader 105 accepts designation of the timecode. For example, the timecode that is automatically counted up may be designated according to the image capturing clock time of the volumetric capture system. Additionally, the manager may manually designate an arbitrary timecode. Moreover, an input from an external system may be accepted, and designation of the timecode may be accepted by way of the distribution system 400, for example.

In S8006, the uploader 105 reads out the volumetric data corresponding to the timecode designated in S8005 from the database 104 and uploads the volumetric data to the transmission destination with which the connection is established. Thus, the server that functions as the transmission server obtains the volumetric data that is the material data generated for each timecode.

As described above, with the processing illustrated in FIG. 8A being executed, the volumetric data is uploaded from the volumetric capture system 100 to the distribution system 400 in units of timecodes. In other words, although it is possible to designate an arbitrary timecode, the timecode of the volumetric data deployed by the distribution system 400 from the data transfer server group 4100 to the image generation server group 4200 can be controlled only by the uploader 105. In a case where a time lag of data transfer is ignored, the timecode of the volumetric data deployed in the distribution system 400 is always the same.

### Data Transfer Processing

Details of the data transfer processing in the data transfer server 410N are described with reference to FIG. 8B. FIG. 8B is a flowchart illustrating a flow of the data transfer processing. With the data transfer processing being executed, the volumetric data is transferred from the data transfer server to the image generation server. This processing is executed with the data transfer control unit 711 performing overall control of the data transfer server 410N including the other functional unit other than the data transfer control unit 711. Note that, the software that executes the above functions is also referred to as the server application of the data transfer server 410N in FIG. 7A.

In S8101, the data transfer control unit 711 obtains the own ID from the attribute information of itself (the data transfer server). Since the details of the own ID are described with reference to FIG. 6B, description herein is omitted.

In S8102, the data transfer control unit 711 obtains the distribution event ID set to itself from the attribute information of itself obtained in S8101. Since the details of the distribution event ID are described with reference to FIGS. 2A to 2E, description herein is omitted.

In S8103, the data transfer control unit 711 designates the distribution event ID and the own ID via the connection configuration obtainment unit 712 and obtains the connection configuration information 600 of the corresponding distribution event from the connection configuration management server 401. Since the details of the connection configuration information are described with reference to FIGS. 6A to 6C, description herein is omitted.

In S8104, the data transfer control unit 711 establishes the connection with the transmission source of the own ID via the data reception unit 713 according to the connection configuration information obtained in S8103. In and after S8105, it is possible to receive the volumetric data. Note that, the processing of establishing the connection is common in TCP/IP communication and the like of the network; for this reason, detailed description thereof is omitted.

In S8105, the data transfer control unit 711 establishes the connection with the transmission destination via the data transmission unit 714 according to the connection configuration information obtained in S8103. In and after S8106, it is possible to transmit the volumetric data.

Additionally, in a case where multiple transmission destinations are designated in the connection configuration information, the data transfer control unit 711 establishes the connection with each of the transmission destinations via the data transmission unit 714.

In S8106 to S8109, the data transfer control unit 711 repeatedly executes the following processing. An interval of the repeated execution of the processing from S8106 to S8109 uses the same FPS as that of the interval of the repeated upload processing illustrated in FIG. 8A. In this case, 59.94 FPS is used as an example.

In S8107, the data transfer control unit 711 receives the volumetric data from the transmission source of itself via the data reception unit 713.

In S8108, the data transfer control unit 711 transmits the volumetric data received in S8107 to the transmission destination of itself via the data transmission unit 714. Additionally, in a case where there are multiple transmission destinations, the same volumetric data is transmitted to each of the transmission destinations.

The data transmission processing described above is executed by all the data transfer servers included in the data transfer server group 4100. Although the data transfer servers are the virtual servers having the same server application and the same specification, with every server obtaining the IP addresses of the parent ID (the transmission source) and the child ID (the transmission destination) of the own ID from the connection configuration information, it is possible to structure the distribution connection configuration by the same processing. In addition, with the above-described processing illustrated in FIG. 8B being executed, the uploaded volumetric data is transferred, in units of timecodes, from the volumetric capture system 100 to the data transfer server group 4100 structuring the distribution connection configuration.

### Generation Processing of Virtual Viewpoint Image

Details of the generation processing of the virtual viewpoint image in the image generation server 420N are described with reference to FIG. 8C. FIG. 8C is a flowchart illustrating a flow of the generation processing of the virtual viewpoint image. This processing is executed with the image generation unit 724 performing overall control of the image generation server 420N including the other block other than the image generation unit 724. Note that, the software that executes the above functions is also referred to as the server application of the image generation server 420N in FIG. 7B.

In S8201, the image generation unit 724 obtains the own ID from the attribute information of itself (the image generation server). Since the details of the own ID are described with reference to FIG. 6B, description herein is omitted.

In S8202, the image generation unit 724 obtains the distribution event ID set to itself from the attribute information of itself obtained in S8201. Since the details of the distribution event ID are described with reference to FIGS. 2A to 2E, description herein is omitted.

In S8203, the image generation unit 724 designates the distribution event ID and the own ID via the connection configuration obtainment unit 721 and obtains the connection configuration information 600 of the corresponding distribution event from the connection configuration management server 401. Since the details of the connection configuration information are described with reference to FIGS. 6A to 6C, description herein is omitted.

In S8204, the image generation unit 724 arranges the virtual space generated based on the background model and the texture data for the background model uploaded in advance. An example of the virtual space in a case of FIG. 2C includes the 3D model of the background in the image capturing region 120 of the field in the stadium and the like. Note that, the virtual space of the background is not limited to the field and may be a CG background and the like that do not exist in the real world.

In S8205, the image generation unit 724 establishes the connection with the transmission source of the own ID via the data reception unit 722 according to the connection configuration information obtained in S8203. In and after S8206, it is possible to receive the volumetric data from the transmission source.

In S8206, the image generation unit 724 establishes the connection with the user terminal that is the transmission destination of the own ID via the data transmission unit 725 according to the connection configuration information obtained in S8203. In and after S8207, it is possible to receive the virtual camera information from the user terminal as the transmission destination and transmit the virtual viewpoint image to the user terminal.

Note that, in a case where a connection request from the user terminal ID that is different from the user terminal ID associated with the own image generation server ID illustrated in FIG. 6C in the connection configuration information is received, the image generation server may reply that the connection is not allowed. That is, in a case where there is a request of the connection from the user terminal to which the user terminal ID that is different from the user terminal ID associated with the own ID is applied in the connection configuration information, the server operating as the image generation server may perform the processing described as below. It is possible to notify the user terminal to which the different user terminal ID is applied as described above that the connection is not allowed. Additionally, the association between the image generation server ID and the user terminal ID illustrated in FIG. 6C in the connection configuration information may not be determined in advance, and the image generation server ID that is not associated may be allocated in the order of the user terminal that requests the connection in S8206, and the connection configuration information may be updated.

In S8207 to S8212, the image generation unit 724 repeatedly executes the following processing. An interval of the repeated execution of the processing from S8207 to S8212 is according to the FPS of rendering processing of the image generation server 420N. In this case, 59.94 FPS is used as an example. Note that, the same FPS as that of the interval of the repeated upload processing illustrated in FIG. 8A may be used.

In S8208, the image generation unit 724 receives the volumetric data from the data transfer server as the transmission source of itself via the data reception unit 722 and reads out the volumetric data to the virtual space arranged in S8204.

In S8209, the image generation unit 724 obtains the virtual camera information from the user terminal connected with itself via the virtual camera control unit 723. Note that, the image generation unit 724 may save the last virtual camera information with the user terminal ID connected with itself via the virtual camera control unit 723. After a case where no virtual camera information is received from the connected user terminal for a certain time (a predetermined time) is detected, and in a case where the connection is established again with the user terminal of the same user terminal ID, the last virtual camera information saved may be used.

In S8210, the image generation unit 724 generates the virtual viewpoint image by using the volumetric data and the virtual camera information obtained until S8209. In S8211, the image generation unit 724 transmits the virtual viewpoint image generated until S8210 to the user terminal with which the connection is established in S8206 via the data transmission unit 725.

The generation processing of the virtual viewpoint image described above is executed by all the image generation servers included in the image generation server group 4200. Although the image generation servers are the virtual servers having the same server application and the same specification, it is possible to structure the configuration described as below. To be specific, the image generation server can structure the distribution connection configuration (the tree structure) by the same processing by obtaining the IP address of the parent ID (the transmission source) of the own ID and the user terminal ID associated with itself from the connection configuration information. In addition, the uploaded volumetric data and the virtual camera information of each user terminal are used in units of timecodes, and the corresponding virtual viewpoint images are generated by all the image generation servers. These virtual viewpoint images are displayed on the manipulated user terminal.

### Functional Configuration of User Terminal

Subsequently, a configuration of the user terminal 440N is described. FIG. 9A is a diagram illustrating a functional configuration example of the user terminal 440N. As illustrated in FIG. 9A, the user terminal 440N includes a user manipulation control unit 901, a distribution event selection unit 902, a connection configuration obtainment unit 903, a virtual camera control unit 904, a data transmission and reception unit 905, and an image display unit 906.

The user terminal 440N uses the function illustrated in FIG. 9A to accept the manipulation of the virtual camera by the user and transmits the manipulation to the image generation server 420N as the virtual camera information. As a response, the virtual viewpoint image is received from the image generation server 420N to be displayed, and a viewing experience of the virtual viewpoint image is provided to the user.

The user manipulation control unit 901 performs overall control of the user terminal 440N including the functional unit other than the user manipulation control unit 901 and executes the manipulation of the virtual camera and the display processing of the virtual viewpoint image in the user terminal 440N.

The distribution event selection unit 902 displays a distribution event list via the image display unit 906 and accepts selection of the distribution event from the user. Details of the distribution event list are described with reference to FIG. 10A.

The connection configuration obtainment unit 903 obtains the connection configuration information 600 from the connection configuration management server 401. Since the details of the connection configuration information 600 are described with reference to FIGS. 6A to 6C, description herein is omitted. The virtual camera control unit 904 obtains the position and the orientation and the like related to the virtual camera manipulated by the user and controls the virtual camera information. Since the details of the virtual camera and the virtual camera information are described with reference to FIGS. 3A to 3D, description herein is omitted.

The data transmission and reception unit 905 performs transmission the virtual camera information to the image generation server 420N and reception of the virtual viewpoint image from the image generation server 420N. The image display unit 906 performs displaying of the virtual viewpoint image received from the image generation server 420N and displaying of the distribution event list. Details of the display processing and a display example of the virtual viewpoint image are described with reference to FIG. 10 and FIGS. 11A to 11F.

### Hardware Configuration of User Terminal

Next, a hardware configuration of the user terminal 440N is described. FIG. 9B is a diagram illustrating a hardware configuration example of the user terminal 440N. The user terminal 440N includes a central processing unit (CPU) 911, a random access memory (RAM) 912, and a read only memory (ROM) 913. The user terminal 440N additionally includes a manipulation input unit 914, a display unit 915, and an I/F 916.

The CPU 911 executes processing by using a program and data stored in the RAM 912 or the ROM 913. The CPU 911 performs operation control of overall the user terminal 440N and executes processing to implement each function illustrated in FIG. 9A. Note that, the user terminal 440N may include one or more pieces of dedicated hardware different from the CPU 911, and the dedicated hardware may execute at least a part of the processing by the CPU 911. An example of the dedicated hardware includes the ASIC (application specific integrated circuits), the FPGA (field programmable gate array), the DSP (digital signal processor), and the like.

The ROM 913 holds the program and the data. The RAM 912 includes a working area that temporarily stores the program and the data read out from the ROM 913. Additionally, the RAM 912 provides the working area used in a case where the CPU 911 executes each processing.

The manipulation input unit 914 is, for example, a touch panel that obtains manipulation information inputted by the manipulation by the user. For example, the manipulation by the user performed on the virtual camera, the manipulation to select the distribution event, and the like are accepted. Note that, the manipulation input unit 914 may be connected with an external controller to accept input information related to the manipulation by the user. Note that, the external controller is, for example, a three-axis controller such as a joystick, a mouse, or the like. The external controller is not limited thereto.

The display unit 915 is a touch panel, a screen, or the like that displays the virtual viewpoint image, the distribution event list, and the like. Note that, in a case of the touch panel, a configuration integrally including the manipulation input unit 914 and the display unit 915 is applied. The I/F (external interface) 916 performs, for example, transmission and reception of the information with the image generation server 420N and the connection configuration management server 401 via the Internet and the like.

### Display Processing of Virtual Viewpoint Image

The display processing of the virtual viewpoint image in the user terminal 440N is described with reference to FIG. 10 and FIGS. 11A to 11F. FIG. 10 is a flowchart illustrating a flow of the display processing of the virtual viewpoint image. This processing is executed with the user manipulation control unit 901 performing overall control of the user terminal 440N including the functional unit other than the user manipulation control unit 901. Additionally, the user terminal used in the screen display example in FIGS. 11A to 11F is a tablet. Note that, the user terminal is not limited to the tablet and may be a smartphone or a head mounted display (HMD).

In S1001, the user manipulation control unit 901 requests the authentication server (not illustrated) to perform authentication processing of the user. Although detailed description is omitted since the authentication processing is common, the authentication processing is performed by using a user ID, a password, and the like, and a result thereof is replied to the user terminal 440N. If the authentication processing result is true, the processing proceeds to S1002. Note that, if the authentication processing result is false, the processing does not proceed to S1002, and the processing in S1001 is repeatedly executed until the authentication processing result becomes true.

In S1002, the user manipulation control unit 901 displays a screen including the distribution event list via the image display unit 906 and accepts selection of the desired distribution event by the manipulation by the user from the distribution event list. Details of the screen including the distribution event list are described with reference to FIG. 11A.

### Screen Including Distribution Event List

FIG. 11A is a diagram illustrating a screen example including the distribution event list. A screen 1100 including the distribution event list is a screen displayed on the display unit 915 of the user terminal 440N and can display information related to multiple distribution events. FIG. 11A illustrates a case where distribution event information 1101 and distribution event information 1102 are displayed. Note that, although only two pieces of distribution event information 1101 and 1102 are displayed in FIG. 11A, it is possible to scroll the screen 1100, and it is possible to display multiple pieces of distribution event information other than the distribution event information 1101 and 1102.

As illustrated in FIG. 11A, the distribution event information 1101 includes a thumbnail 1111, a title 1112, starting clock time 1113, a purchase button 1121, and a view button 1122. Note that, the distribution event information 1101 is not limited to include the above information and may include other information as long as it is information related to the distribution event. As with the distribution event information 1101, the distribution event information 1102 includes a thumbnail, a title, starting clock time, a purchase button, and a view button. The distribution event information displayed on the display unit 915 of the user terminal 440N is obtained from the connection configuration management server 401.

The thumbnail 1111 displays an image and the like that show contents of the distribution event to be recognized at first sight. The title 1112 displays a name and the like of the distribution event. The starting clock time 1113 displays the event starting clock time.

The purchase button 1121 performs screen transition to a ticket purchase page of the corresponding distribution event (not illustrated). A ticket purchase method of the distribution event is common; for this reason, description is omitted. Note that, as illustrated in FIG. 11A, a display state of the purchase buttons 1121 and 1123 may be changed to control whether to allow for pressing of the buttons. For example, the button corresponding to the ticket that is already purchased by the corresponding user may be grayed out to be an invalid state showing that it cannot be pressed, as illustrated by the purchase button 1121. On the other hand, the button corresponding to the ticket that is not purchased yet by the corresponding user may be in a valid state showing that it can be pressed, as illustrated by the purchase button 1123.

The view button 1122 starts viewing of the corresponding distribution event in a case where pressing of the view button 1122 is accepted, and the processing proceeds to S1003. Note that, as illustrated in FIG. 11A, a display state of the view buttons 1122 and 1124 may be changed to control whether to allow for pressing of the buttons. For example, the button corresponding to the ticket that is already purchased by the corresponding user is in a valid state showing that it can be pressed, as illustrated by the view button 1122. The button corresponding to the ticket that is not purchased yet by the corresponding user may be grayed out to be an invalid state showing that it cannot be pressed, as illustrated by the view button 1124.

In S1003, the user manipulation control unit 901 designates the distribution event ID of the distribution event designated in S1002 and obtains the connection configuration information 600 from the connection configuration management server 401. Since the details of the connection configuration information 600 are described with reference to FIGS. 6A to 6C, description herein is omitted.

In S1004, the user manipulation control unit 901 is connected to the corresponding image generation server by using the image generation server ID and the IP address to which the user terminal itself is connected based on the connection configuration information 600 obtained in S1003. Note that, the obtained image generation server ID and attribute information may be saved.

### Screen in Case of Being Connected to Image Generation Server

FIG. 11B is a diagram illustrating a screen example displayed on the user terminal 440N in a case where the user terminal 440N is connected to the image generation server. As illustrated in FIG. 11B, a screen 1130 displays "Connecting..." 1131 indicating that it is in the middle of the connection of the user terminal 440N to the image generation server. Note that, the screen 1130 may also display the information related to the distribution event selected in S1002. As the information related to the distribution event selected in S1002, for example, the name or the thumbnail of the corresponding distribution event may be displayed.

### Screen in Case of Completing Connection to Image Generation Server

FIG. 11C is a diagram illustrating a screen example displayed on the user terminal 440N in a case of completing the connection of the user terminal 440N to the image generation server. As illustrated in FIG. 11C, the screen of the display unit 915 displays a virtual viewpoint image 1140 that is the virtual viewpoint image expressing the virtual space and expressing the virtual space arranged in S8204 during the generation processing of the virtual viewpoint image by the image generation server illustrated in FIG. 8C. In the example herein, the virtual viewpoint image 1140 is the field and the like in the stadium. The virtual viewpoint image 1140 generated by deploying the virtual space on the image generation server and using the information related to the viewpoint indicating the position and the orientation of the virtual camera as a predetermined initial value is transmitted to the user terminal and displayed on the display unit 915.

Note that, the association between the user terminal and the image generation server illustrated in FIG. 6C may be notified sequentially to the connection configuration management server 401 from the user terminal in the order of completing the processing in S1004, and the user terminal ID may be allocated to the image generation server ID in the order of being connected and may be reflected to the connection configuration information 600.

In S1005 to S1009, the user manipulation control unit 901 repeatedly executes the following processing. An interval of the repeated execution of the processing from S1005 to S1009 is according to a frame rate of the display processing of the user terminal. In a case where the user terminal is the tablet, the frame rate is 60 FPS or the like. Note that, after the connection to the image generation server in S1004, the processing from S1005 to S1009 is repeated during the distribution event.

In S1006, the user manipulation control unit 901 accepts the manipulation by the user and operates the position and the orientation of the virtual camera and the like. Since the details of the operation of the virtual camera are described with reference to FIGS. 3A to 3D, description herein is omitted. Additionally, since the manipulation method of the virtual camera using the tablet is publicly known, description is omitted.

In S1007, the user manipulation control unit 901 transmits the virtual camera information including the position and the orientation of the virtual camera and the like operated until S1006 to the already-connected image generation server. This virtual camera information is received by the image generation server in S8209 of the image generation processing by the image generation server illustrated in FIG. 8C.

Note that, the user manipulation control unit 901 may save the last virtual camera information transmitted to the image generation server. In a case where the user terminal is connected with the image generation server again by power-OFF and power-ON, for example, the operation may be restarted from the transmission of the saved virtual camera information. That is, after the connection with the server operating as the image generation server is disconnected, the user terminal may transmit the information related to the last viewpoint described above to the server operating as the image generation server described above in a case of being connected again. Note that, in a case where the user terminal is connected with the image generation server again by power-OFF and power-ON, for example, the operation may be restarted by using the initial position and the initial orientation of the virtual camera information. That is, in a case of accepting the reconnection from the above-described user terminal, the server operating as the image generation server may generate the virtual viewpoint image by using the information related to the viewpoint of the predetermined initial value.

In S1008, the user manipulation control unit 901 receives the virtual viewpoint image from the already-connected image generation server and displays the virtual viewpoint image. This virtual viewpoint image is generated and transmitted by the image generation server in S8210 and S8211 of the image generation processing illustrated in FIG. 8C. A display example of the virtual viewpoint image in this process is described with reference to FIGS. 11D to 11F.

The above display processing of the virtual viewpoint image is executed by all the user terminals included in the user terminal group 4400. The user terminals may be different device types (the tablet, the HMD, and the like), which are operated by client applications corresponding to the types, respectively. The client applications have the same functional configuration, and the functional unit described with reference to FIG. 9A executes the processing. The client applications each can obtain the IP address of the image generation server associated with the own user ID from the user ID and the connection configuration information. In addition, in each user terminal, it is possible to manipulate the virtual camera independently and display the virtual viewpoint image from the corresponding viewpoint. In this case, with reference to FIGS. 11D to 11F, an example in which three user terminals manipulate the virtual cameras independently and each display the virtual viewpoint image from the different viewpoints by using the same volumetric data is described. FIGS. 11D to 11F are the display unit 915 of the different three user terminals. Note that, although only a case of the tree user terminals is described for the sake of simplifying the description, the number is not limited and may be 100 or 1000, for example.

First, an example of the volumetric data is the same as the volumetric data "Data1A226730" at the timecode "19:01:02.034" illustrated in FIGS. 2A and 2C.

As described in the distribution processing of the virtual viewpoint image illustrated in FIGS. 8A to 8C, in the distribution connection configuration of the distribution system 400, the designation of the timecode is performed by one portion of the uploader 105. Therefore, the same volumetric data according to the timecode designated by the uploader 105 is transferred to the image generation server group 4200.

Thus, three user terminals 4401, 4411, and 4421 illustrated in FIGS. 11D to 11F display virtual viewpoint images 1150, 1160, and 1170 of the different viewpoints using the same volumetric data, respectively. In this scene, as illustrated in FIG. 2C, the offload pass is performed in the rugby game.

On the user terminal 4401 illustrated in FIG. 11D, using the same volumetric data, the virtual viewpoint image that is viewed from the viewpoint of the virtual camera manipulated to be at the position and the orientation to look down from above the field while the player performing the offload pass is positioned at the front is displayed.

On the user terminal 4411 illustrated in FIG. 11E, using the same volumetric data, the virtual viewpoint image that is viewed from the viewpoint of the virtual camera manipulated to be at the position and the orientation to look down from above the field while the player performing the offload pass is positioned in the back is displayed.

On the user terminal 4421 illustrated in FIG. 11F, using the same volumetric data, the virtual viewpoint image that is viewed from the viewpoint obtained by manipulating the virtual camera to the position and the orientation to look from the side of the field while the player performing the offload pass is positioned at the front is displayed.

Incidentally, in the technique disclosed in Japanese Patent Laid-Open No. 2019-145017, only the data related to the space and the object regarding a camera path saved in advance in a case of generating the virtual viewpoint image is obtained and rendered. Therefore, it has been impossible to generate multiple virtual viewpoint images of viewpoints that are different from each other. For example, the user has been unable to view the virtual viewpoint image corresponding to a view from the virtual viewpoint that corresponds to a camera path other than the camera path saved in advance.

As described with reference to FIGS. 11D to 11F, with use of the distribution system 400 of the present embodiment, the user terminal can manipulate the virtual viewpoint that is a corresponding arbitrary viewpoint, and it is possible to view the virtual viewpoint image expressing a view from the corresponding virtual viewpoint.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to generate multiple virtual viewpoint images of viewpoints that are different from each other.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-019135, filed February 7, 2025, which is hereby incorporated by reference wherein in its entirety.

What is claimed is:

1. An information processing apparatus configured to set a configuration of an information processing system including an image generation server configured to generate a virtual viewpoint image corresponding to a viewpoint based on inputted data, which is information related to the viewpoint and material data, and a transmission server configured to transmit the inputted material data, the information processing apparatus comprising:
at least one memory that stores instructions; and
at least one processor that executes the instructions to:
obtain first information indicating a transmittable data amount per unit time in the transmission server, second information indicating a data amount of the material data inputted to the information processing system, and third information indicating the number of the image generation server; and
determine the number of the transmission server based on the first information, the second information, and the third information.

2. The information processing apparatus according to claim 1, wherein
the transmission server is configured with a tree structure.

3. The information processing apparatus according to claim 2, wherein
in determining, the number the transmission server by using a greedy algorithm is determined.

4. The information processing apparatus according to claim 1, wherein
the information related to the viewpoint is set for each event.

5. The information processing apparatus according to claim 1, wherein
the material data includes three-dimensional shape data of an object.

6. The information processing apparatus according to claim 5, wherein
the material data further includes acoustic data.

7. An information processing system comprising:
an image generation server configured to generate a virtual viewpoint image corresponding to the viewpoint based on inputted data, which is information related to a viewpoint and material data;
a transmission server configured to transmit the inputted material data; and
a setting server configured to set the transmission server, wherein
the setting server includes
an obtainment unit configured to obtain first information indicating a transmittable data amount per unit time in the transmission server, second information indicating a data amount of the material data inputted to the information processing system, and third information indicating the number of the image generation server, and
a determination unit configured to determine the number of the transmission server based on the first information, the second information, and the third information.

8. The information processing system according to claim 7, wherein
the setting server further includes an activation control unit configured to activate the transmission server and the image generation server.

9. The information processing system according to claim 8, wherein
the obtainment unit obtains event information related to an event in which the virtual viewpoint image is distributed, and
the activation control unit activates, in a case where a reaching of event starting clock time designated in the event information is detected, the transmission server and the image generation server.

10. The information processing system according to claim 7, wherein
the transmission server includes
an obtainment unit configured to obtain the material data generated for each timecode, and
a transmission unit configured to transmit the obtained material data to the image generation server, and
the image generation server includes
a reception unit configured to receive the material data transmitted by the transmission unit of the transmission server and the information related to a plurality of the viewpoints designated by a plurality of user terminals, respectively,
a generation unit configured to generate a plurality of virtual viewpoint images corresponding to the plurality of viewpoints, respectively, based on the material data and the information related to the plurality of viewpoints, and
a distribution unit configured to distribute the plurality of virtual viewpoint images to the plurality of user terminals designating the corresponding virtual viewpoints of the corresponding plurality of virtual viewpoint images.

11. The information processing system according to claim 7, further comprising:
a first management unit configured to manage an ID identifying each of the image generation server and the transmission server, a parent node ID identifying a transmission source of the material data, and a child node ID identifying a transmission destination of the material data in association with each other.

12. The information processing system according to claim 7, further comprising:
a user terminal connected with the image generation server; and
a second management unit configured to manage a user terminal ID identifying the user terminal and an image generation server ID identifying the image generation server in association with each other.

13. The information processing system according to claim 12, wherein
the second management unit applies the user terminal ID to the user terminal connected to the image generation server in the order of starting the connection with the image generation server and manages the image generation server ID and the user terminal ID in association with each other.

14. The information processing system according to claim 12, wherein
the image generation server further includes a saving unit configured to save the last information related to the viewpoint received from the user terminal in association with the user terminal ID.

15. The information processing system according to claim 14, wherein
in a case where reconnection is accepted from the user terminal that has the same user terminal ID as the user terminal ID after a case where there is no connection from the user terminal of the user terminal ID for a predetermined time is detected, the image generation server generates the virtual viewpoint image by using the last information related to the viewpoint saved in the saving unit.

16. The information processing system according to claim 12, wherein
the image generation server and the user terminal are connected to each other on a one-to-one basis or a one-to-multiple basis.

17. The information processing system according to claim 7, further comprising:
a third management unit configured to manage the material data in units of timecodes.

18. The information processing system according to claim 7, wherein
the material data is inputted in units of timecodes.

19. An information processing method to set a configuration of an information processing system including an image generation server configured to generate a virtual viewpoint image corresponding to a viewpoint based on inputted data, which is information related to the viewpoint and material data, and a transmission server configured to transmit the inputted material data, the information processing method comprising:
obtaining first information indicating a transmittable data amount per unit time in the transmission server, second information indicating a data amount of the material data inputted to the information processing system, and third information indicating the number of the image generation server; and
determining the number of the transmission server based on the first information, the second information, and the third information.

20. A non-transitory computer readable storage medium storing a program for causing a computer to perform an information processing method to set a configuration of an information processing system including an image generation server configured to generate a virtual viewpoint image corresponding to a viewpoint based on inputted data, which is information related to the viewpoint and material data, and a transmission server configured to transmit the inputted material data, the information processing method comprising:
obtaining first information indicating a transmittable data amount per unit time in the transmission server, second information indicating a data amount of the material data inputted to the information processing system, and third information indicating the number of the image generation server; and
determining the number of the transmission server based on the first information, the second information, and the third information.
